(19) United States
(12) Patent Application Publication
(10) Pub. No.: US 2013/0225192 A1
(43) Pub. Date: Aug. 29, 2013

(54) BASE STATION DEVICE, COMMUNICATION SYSTEM, MANAGEMENT DEVICE, AND METHODS RELATING TO THE SAME

(71) Applicants: Takashi Yamamoto, Osaka-shi (JP); Yoji Okada, Osaka-shi (JP); Yoshizo Tanaka, Osaka-shi (JP); Kenichi Murakami, Osaka-shi (JP)

(72) Inventors: Takashi Yamamoto, Osaka-shi (JP); Yoji Okada, Osaka-shi (JP); Yoshizo Tanaka, Osaka-shi (JP); Kenichi Murakami, Osaka-shi (JP)

(73) Assignee: SUMITOMO ELECTRIC INDUSTRIES, LTD., Osaka-shi, Osaka (JP)

(21) Appl. No.: 13/881,600

(22) PCT Filed: Nov. 11, 2011
(86) PCT No.: PCT/JP2011/076039

§ 371 Date: Apr. 25, 2013

(30) Foreign Application Priority Data
Nov. 12, 2010 (JP) 2010-254260

(51) Int. Cl. H04W 72/10

(52) U.S. Cl. CPC H04W 72/10
USPC 455/452.1

(57) ABSTRACT

New technical means for setting a position of a blank radio resource is provided. A base station device includes: a setting unit 24 that sets a blank radio resource in a usable radio resource; and an acquisition unit 26 that acquires information indicating a position of a blank radio resource in another base station device. The setting unit 24 adjusts the position of the blank radio resource, based on the information indicating the position of the blank radio resource in the another base station device.

### TECHNICAL FIELD

The present invention relates to a base station device, a communication system, a management device, and methods relating to the same.

### BACKGROUND ART

A cellular type communication system is established by installing a number of high-power macro base station devices each forming a relatively wide radio communication area which is called a macro cell.

In communication standards such as LTE (Long Term Evolution), it is assumed to install, in addition to macro base station devices, femto base station devices each forming a femto cell narrower than the macro cell (refer to Non-Patent Literature 1). Femto base station devices are smaller in size than macro base station devices.

While macro base station devices are installed by a telecommunications carrier managing the communication system, femto base station devices are installed mainly by individuals and companies as customers (users) of the communication system. For example, by installing a femto base station device in a house or an office of a company in a macro cell, it is possible to improve communication environment or the like in the place where the femto base station device is installed.

Further, in the LTE, it is also considered to install, separately from femto base station devices, small-size base station devices (pico base station devices) each forming a cell (pico cell) narrower than the macro cell (refer to Non-Patent Literature 2).

If the number of terminals in a macro cell of a macro base station device significantly increases for such a reason that an area having a very high population density is included in the macro cell, it is expected that a sufficient channel capacity for such many terminals cannot be secured by the macro base station device alone.

So, the terminals in the macro cell are connected not to the macro base station device but preferentially to the pico base station devices. Thereby, the communication load on the macro base station device can be reduced, resulting in improved throughput of the entire system.

In the LTE, both the macro base station device and the pico base station device are also referred to as “eNodeB (eNB)”, and all the terminals of subscribers of the communication system are allowed to access the macro and pico base station devices. That is, the macro and pico base station devices are public base station devices.

On the other hand, the femto base station device is also referred to as “Home eNB (HeNB)”, and terminals allowed to access the femto base station device may be limited so that the installer or the like of the femto base station device can preferentially use the femto base station device. That is, the femto base station device is a base station device that can be privately used.

### CITATION LIST

### Patent Literature

Non-Patent Literature 1: 3GPP, “TS22.220 V 10.3.0 Service requirements for Home NodeB (HNB) and Home eNodeB (HeNB)”, 2010-06
Non-Patent Literature 2: 3GPP, “TS36.104 V 10.0.0 Base Station (BS) radio transmission and reception”, 2010-09

### SUMMARY OF THE INVENTION

### Problems to be Solved by the Invention

When a femto base station device is privately used, general terminals owned by persons other than relevant persons of the femto base station device are limited in access to the femto base station device. That is, the general terminals, even if they are present in the femto cell, are preferentially connected to a macro base station device, and are not connected to the femto base station device at all or are connected to the femto base station device only in limited circumstances.

Accordingly, it is desired that the privately used femto base station device does not adversely affect the operation of the public base station device such as the macro base station device.

For example, when a control signal contained in a frame transmitted from the macro base station device is subjected to radio wave interference from the femto base station device, a terminal accessing the macro base station device may not be able to acquire the control signal needed for acquisition of a data signal. If the terminal acquires the control signal, the terminal can normally recognize the data signal in spite of some interference. However, if the terminal cannot acquire the control signal, the terminal cannot normally recognize the data signal.

Accordingly, it is desired that the femto base station device installed in the macro cell does not cause interference to the macro cell, more specifically, that the femto base station device does not cause interference to the control signal contained in the transmission frame from the macro base station device.

For this purpose, it is considered that the femto base station device may set a radio resource in which interference to the macro cell needs to be avoided, as a blank radio resource, in usable radio resources (a time resource and/or a frequency resource). For example, the femto base station device may set a blank section (blank subframe) in a frame position corresponding to a transmission section of the control signal contained in the transmission frame of the macro base station device.

Further, the femto base station device may provide an unused frequency (blank carrier) among frequencies (carriers) that the femto base station device can use.

By setting a radio resource in which interference to the macro cell needs to be avoided, as a blank radio resource (blank section or blank carrier), it is possible to reduce interference to the macro cell with respect to the blank radio resource.

As described above, the blank radio resource is useful for protecting signals such as a control signal transmitted from another neighboring base station device. Further, the blank radio resource is useful not only for protection of the control signal but also in various situations in which inter-cell interference needs to be avoided for part of radio resources.

However, there are cases where not only the macro base station device but also a pico base station device is installed as a public base station device in the macro cell in which the femto base station device is installed.

Therefore, if the position in which the blank radio resource is to be set is determined considering only the signal transmitted from the macro base station device that forms the cell to be prevented from interference, sufficient consideration to the pico base station device may not be obtained.

As described above, the blank radio resource is useful for avoiding interference to the cell of another base station device. However, if only the avoidance of interference to the cell of the another base station device is considered, the position of the blank radio resource may become inappropriate, depending on the arrangement of the plurality of base station devices.

Therefore, an object of the present invention is to provide new technical means for setting a position of a blank radio resource.

### Solution to the Problems

(1) An aspect of the present invention is a base station device comprising: a setting unit that sets a blank radio resource in a usable radio resource; and an acquisition unit that acquires information indicating the position of a blank radio resource in another base station device, wherein the setting unit adjusts the position of the blank radio resource, based on the information indicating the position of the blank radio resource in the another base station device.

According to the present invention, the base station device can adjust the position of the blank radio resource in the base station device, based on the blank radio resource position in the another base station device.

The information indicating the blank radio resource position may not directly indicate the position of the blank radio resource, but may indirectly indicate the position of the blank radio resource by indicating the position of the actually used radio resource in the usable radio resource.

The position of the blank radio resource is a position on the time axis when the radio resource is the time resource, for example, and is a position on the frequency axis when the radio resource is the frequency resource, for example.

(2) Preferably, the acquisition unit acquires, from a target base station device to be referred to for the position of a blank radio resource among a plurality of other base station devices, information indicating the position of a blank radio resource in the target base station device, and the setting unit adjusts the position of the blank radio resource, based on the information indicating the position of the blank radio resource in the target base station device.

In this case, it is possible to adjust the position of the blank radio resource in the base station device, based on the position of the blank radio resource in the target base station device to be referred to for the position of the blank radio resource.

(3) Preferably, the blank radio resource in the another base station device is a blank radio resource that is set for preventing interference to a cell of still another base station device different from the another base station device.

(4) Preferably, the base station device according to any one of claims 1 to 3, wherein the another base station device is higher in priority of access by a terminal device than the base station device.

(5) In the above (4), preferably, the blank radio resource in the another base station device is a blank radio resource which is set for preventing interference to a cell of a preferential base station device, and the preferential base station device is still another base station device different from the another base station device, and is higher in priority of access by a terminal device than the another base station device.

(6) The another base station device may be lower in priority of access by a terminal device than the base station device.

(7) In the above (6), preferably, the blank radio resource in the another base station device is a blank radio resource which is set for preventing interference to a cell of a preferential base station device, and the preferential base station device is still another base station device different from the another base station device, and is higher in priority of access by a terminal device than the base station device.

(8) Preferably, the preferential base station device is a neighboring base station device that is present in the neighborhood of the base station device.

(9) Preferably, the another base station device is a macro base station device that forms a macro cell.

(10) Preferably, the still another base station device different from the another base station device is a small-size public base station device that forms a cell smaller than a macro cell.

(11) Preferably, the base station device according to any one of above (1) to (10) is a base station device that can be privately used by customers of a telecommunications carrier, such as individuals or companies.

(12) Preferably, the base station device according to any one of above (1) to (9) is a small-size public base station device that forms a cell smaller than a macro cell.

(13) Preferably, the still another base station device different from the another base station device is a second public base station device that forms a cell smaller than a cell of a first small-size public base station device that forms a cell smaller than a macro cell.

(14) Preferably, the setting unit sets the blank radio resource in a position corresponding to the position of the blank radio resource in the another base station device.

(15) Preferably, the setting unit sets the blank radio resource in a position different from the position of the blank radio resource in the another base station device.

(16) Preferably, the radio resource is a time resource or a frequency resource.

(17) Preferably, the base station device further includes a determination unit that determines whether still another base station device different from the another base station device is present in the neighborhood of the base station device, and the setting unit adjusts the position of the blank radio resource, based on a result of the determination as to whether still another base station device different from the another base station device is present in the neighborhood of the base station device.

In this case, the determination unit determines whether still another base station device different from the another base station device is present in the neighborhood of the base station device, and then the setting unit adjusts the position of the blank radio resource. Accordingly, if still another base station device different from the another base station device is present in the neighborhood of the base station device, the setting unit can adjust the position of the blank radio resource, taking into consideration the presence of the still another base station device different from the another base station device.

(18) Preferably, when the determination unit has determined that still another base station device different from the another base station device is present in the neighborhood of the base station device, the setting unit adjusts the position of the blank radio resource, based on the information indicating the position of the blank radio resource in the another base station device.

(19) Preferably, when the determination unit has determined that still another base station device different from the another base station device is not present in the neighborhood of the base station device, the setting unit adjusts the position of the blank radio resource in order to prevent interference to a cell of the another base station device.

(20) Preferably, the determination unit performs the determination as to whether still another base station device different from the another base station device is present in the neighborhood of the base station device, based on information wirelessly transmitted by a neighboring base station device that is present in the neighborhood of the base station device.

(21) Preferably, the determination unit performs the determination as to whether still another base station device different from the another base station device is present in the neighborhood of the base station device, based on transmission power information transmitted by a neighboring base station device that is present in the neighborhood of the base station device.

(22) Preferably, the base station device includes a determination unit that determines whether the preferential base station device is present in the neighborhood of the base station device, and the setting unit adjusts the position of the blank radio resource, based on a result of the determination as to whether the preferential base station device is present in the neighborhood of the base station device.

(23) The determination unit can perform the determination as to whether the preferential base station device is present in the neighborhood of the base station device, based on ID information of the base station device, which is transmitted by a neighboring base station device that is present in the neighborhood of the base station device.

(24) The determination unit can perform the determination as to whether the preferential base station device is present in the neighborhood of the base station device, by determining whether a transmission frame transmitted by a neighboring base station device in the neighborhood of the base station device contains information which allows recognition that the neighboring base station device is the preferential base station device.

(25) The determination unit can perform the determination as to whether the preferential base station device is present in the neighborhood of the base station device, by determining whether a transmission frame transmitted by a neighboring base station device in the neighborhood of the base station device contains information which allows recognition that still another base station device that is present in the neighborhood of the neighboring base station device is the preferential base station device.

(26) The determination unit performs the determination as to whether the preferential base station device is present in the neighborhood of the base station device, taking into consideration a result of measurement of a signal transmitted from the still another base station device.

(27) The determination unit can perform the determination as to whether the preferential base station device is present in the neighborhood of the base station device, based on a monitoring result as to whether a neighboring base station device that is present in the neighborhood of the base station device performs cell range expansion.

(28) The determination unit can perform the determination as to whether still another base station device different from the another base station device is present in the neighborhood of the base station device, based on information acquired via an inter-base-station network.

(29) The determination unit can perform the determination as to whether still another base station device different from the another base station device is present in the neighborhood of the base station device, based on information indicating whether still another base station device different from the another base station device is present in the neighborhood of the base station device, the information being acquired via the inter-base-station network.

(30) Another aspect of the present invention is a base station device which is configured to be able to transmit a transmission frame including information that allows recognition of the type of the base station device, wherein the type of the base station device is based on the priority of access by a terminal device.

(31) Another aspect of the present invention is a base station device which is configured to be able to transmit a transmission frame including information indicating another base station device that is present in the neighborhood of the base station device, and information that allows recognition of the type of the another base station device.

(32) Another aspect of the present invention is a communication system including: a first base station device; a second base station device; and a third base station device, wherein the first base station device is configured to set, in a usable radio resource, a blank radio resource for preventing interference to a cell of the second base station device, and the third base station device acquires information indicating the position of the blank radio resource in the first base station device, and adjusts the position of the blank radio resource, based on the information indicating the position of the blank radio resource in the first base station device.

(33) Another aspect of the present invention is a management device for managing information of a plurality of base station devices, comprising: a storage unit having stored therein information that allows recognition of the type of each of the plurality of base station devices; and an information transmission unit that transmits, to one base station device, when another base station device of a type different from the type of the one base station device is present in the neighborhood of the one base station device, information that allows the one base station device to recognize that the another base station device of the different type is present in the neighborhood of the one base station device.

(34) Another aspect of the present invention is a management device for managing information of a plurality of base station devices, comprising: a storage unit having stored therein information that allows recognition of the type of each of the plurality of base station devices; and an information transmission unit that transmits, to a base station device, information that allows the base station device to recognize the type of another base station device.

(35) Another aspect of the present invention is a method of setting a blank radio resource in a radio resource that a base station device can use, the method comprising the steps of: acquiring information indicating the position of a blank radio resource in another base station device; and adjusting the position of the blank radio resource in the base station device, based on the information indicating the position of the blank radio resource in the another base station device.

(36) Another aspect of the present invention is a method of performing determination regarding a neighboring base station device, the method comprising the steps of: transmitting, from a device provided in an inter-base-station network or a device provided in a network connected to an inter-base-station network, information to be used for determining whether, in the neighborhood of one base station device, another base station device of a type different from the type of the one base station device is present; receiving, by the one base station device, the information transmitted via the inter-base-station network; and performing, based on the information, the determination as to whether, in the neighborhood of the one base station device, another base station device of a type different from the type of the one base station device is present.

(37) Another aspect of the present invention is a method of transmitting information by a base station device, wherein the base station device transmits information that allows recognition of the type of the base station device. The type of the base station device is based on the priority of access by a terminal device.

(38) Another aspect of the present invention is a method of transmitting, by a base station device, information indicating another base station device that is present in the neighborhood of the base station device, wherein the base station device transmits, in addition to the information indicating another base station device that is present in the neighborhood of the base station device, information that allows recognition of the type of the another base station device.

### BRIEF DESCRIPTION OF THE DRAWINGS

FIG. 1 is a configuration diagram of a communication system.

FIG. 2 is a configuration diagram of an inter-base-station network.

FIG. 3 is a diagram showing the structures of DL and UL frames.

FIG. 4 is a diagram showing the structure of a DL frame.

FIG. 5 is a configuration diagram of a base station device (femto base station device).

FIG. 6 is a diagram showing a synchronization information notification method.

FIG. 7 is a diagram showing an ABS arrangement in a femto BS.

FIG. 8 is a diagram showing an ABS arrangement in a macro BS.

FIG. 9 is a diagram showing ABS arrangements (case 1) in a pico BS and a macro BS.

FIG. 10 is a diagram showing an ABS information notification method.

FIG. 11 is a diagram showing ABS arrangements (case 2) in a pico BS and a macro BS.

FIG. 12 is a flowchart showing a determination method based on transmission power.

FIG. 13 is a diagram showing a transmission power notification method.

FIG. 14 is a flowchart showing a determination method based on cell ID.

FIG. 15 is a diagram showing a cell ID notification method.

FIG. 16 is a diagram showing a method of notifying information of subordinate pico cells under a macro BS.

FIG. 17 is a flowchart showing a determination method based on cell type.

FIG. 18 is a diagram showing a cell type notification method.

FIG. 19 is a diagram showing a data structure of cell-type-added own cell information.

FIG. 20 is a flowchart showing a determination method based on a neighboring base station list.

FIG. 21 is a diagram showing a neighboring base station list notification method.

FIG. 22 is a diagram showing a data structure of a cell-type-added neighboring base station list.

FIG. 23 is a flowchart showing a determination method based on cell range expansion.

FIG. 24 is a diagram showing a cell range expansion monitoring method.

FIG. 25 is a diagram showing a method of notifying pico BS information from an inter-base-station network.

FIG. 26 is a diagram showing the configuration of a server.

FIG. 27 shows own cell information (SIB1) to which own cell type information is added.

FIG. 28 is a diagram showing a neighboring base station list (SIB4) to which cell type information is added.

FIG. 29 is a diagram showing an arrangement of base station devices.

FIG. 30 is a diagram showing the priority order of access by a terminal device.

FIG. 31 is a diagram showing ABS arrangements in a CSG femto BS and a pico BS.

FIG. 32 is a diagram showing an ABS information notification method.

FIG. 33 is a diagram showing ABS arrangements in a macro BS and a pico BS.

FIG. 34 is a diagram showing an ABS information notification method.

FIG. 35 is a diagram showing ABS arrangements in a CSG femto BS and a pico BS.

FIG. 36 is a diagram showing an ABS information notification method.

FIG. 37 is a diagram showing ABS arrangements in a CSG femto BS, a macro BS, and a pico BS.

FIG. 38 is a diagram showing ABS arrangements in a CSG femto BS, a macro BS, and a pico BS.

FIG. 39 is a diagram showing ABS arrangements in a CSG femto BS, a macro BS, and a pico BS.

FIG. 40 is a diagram showing ABS arrangements in a CSG femto BS and a pico BS.

FIG. 41 is a diagram showing ABS arrangements in a CSG femto BS and an Open femto BS.

### DESCRIPTION OF EMBODIMENTS

Hereinafter, preferred embodiments of the present invention will be described with reference to accompanying drawings.

### 1. Configuration of Communication System

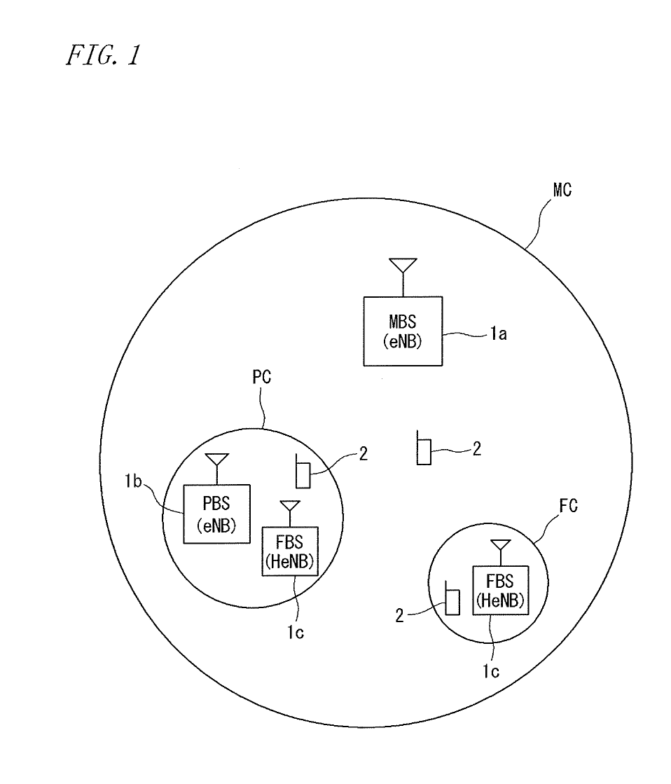

FIG. 1 is a schematic diagram showing a configuration of a wireless communication system. This communication system is a cellular type system including a plurality of base station devices (BS; Base Station) 1. The radio communication system of the present embodiment is, for example, a system for mobile phones to which LTE (Long Term Evolution) is applied, and communication based on the LTE is performed between each base station device 1 and a terminal device (UE; User Equipment) 2. However, the communication scheme is not limited to the LTE.

The plurality of base station devices 1 constituting the communication system may include: a plurality of macro base station devices (Macro Base Stations; MBS) 1a each forming a communication area (macro cell) MC having a size of, for example, several kilometers; pico base station devices (Pico Base Stations; PBS) 1b each forming a pico cell PC; and femto base station devices (Femto Base Stations; FBS) 1c each forming a femto cell FC.

Hereinafter, the macro base station device is referred to as a macro BS, the pico base station device as a pico BS, and the femto base station device as a femto BS.

One or a plurality of pico BS 1b are installed in a macro cell. Each pico BS 1b is installed mainly by a telecommunications carrier, as in the case of the macro BS 1a. By connecting a terminal device 2 in the macro cell MC not to the macro BS 1a but to the pico BS 1b, the communication load on the macro BS 1a is reduced, thereby improving the throughput of the entire system.

One or a plurality of femto BS 1c are installed in the macro cell and/or the pico cell. Each femto BS 1c is installed mainly by an individual or a company that is a customer (user) of the communication system. Installing the femto BS 1c allows, for example, improvement of communication environment in the place where it is installed.

The femto cell FC and the pico cell PC each have a communication area narrower than the macro cell MC, and generally, the femto cell FC is narrower than the pico cell PC, as indicated by their names “femto” and “pico”.

In the LTE, the macro BS 1a and the pico BS 1b are base station devices each referred to as eNB (or simply as NB). Since the macro BS 1a and the pico BS 1b are installed by the telecommunications carriers, all the subscriber terminals of the communication system are allowed to access them, unless there are special circumstances. That is, it can be said that the macro BS 1a and the pico BS 1b are public base station devices. The pico BS 1b is a base station device smaller than (forming a cell smaller than that of) the macro BS 1a.

On the other hand, the femto BS 1c is a base station device referred to as HeNB (or simply as HNB). The femto BS 1c is owned and/or installed by an individual or a company that is a customer (user) of the communication system. That is, it can be said that the femto BS 1c is a base station device that can be privately used by an individual or a company.

The femto BS 1c can limit terminal devices 2 that are allowed to access the femto BS 1c so that the installer of the femto BS 1c or other persons concerned can preferentially use the femto BS 1c. This limitation is realized by setting an access mode on the base station device 1.

The access mode is a mode that allows the base station device 1 to set limitation of wireless access by terminal devices 2. There are three types of access modes, an open access mode, a closed access mode, and a hybrid mode. Each base station device is operated in any of the three types of access modes.

The open access mode is a mode in which all the terminal devices 2 are allowed to access the base station device 1. Since the macro BS 1a and the pico BS 1b installed by the telecommunications carriers are highly public, they are usually operated in the open access mode. Therefore, all the subscriber terminal devices 2 of the communication system are allowed to access the macro BS 1a or the pico BS 1b.

The closed access mode is a mode in which only terminal devices 2 that are registered as terminal devices 2 allowed to use the base station device 1 set in this mode are allowed to access the base station device 1. The registration of terminal devices 2 may be performed in the base station device 1 set in the closed access mode, or in another device to which the base station device 1 can be connected.

Hereinafter, when simply referred to as a “femto BS 1c”, it is a femto BS 1c set in the closed access mode.

If it is desired to particularly indicate that a femto BS 1c is a femto BS 1c set in the closed access mode, the femto BS 1c set in the closed access mode may be referred to as a “CSG (Closed Subscriber Group) femto BS 1c”.

The hybrid mode is a mode in which all the terminal devices 2 are basically allowed to access, but a registered terminal device 2 is treated preferentially over an unregistered terminal device 2, and the unregistered terminal device 2 may not be allowed to access.

The femto BS 1c set in the open access mode functions as a public base station device. Hereinafter, the femto BS 1c set in the open access mode is referred to as an “Open femto BS”.

The femto BS 1c set in the hybrid mode may be regarded as a CSG femto BS or an Open femto BS.

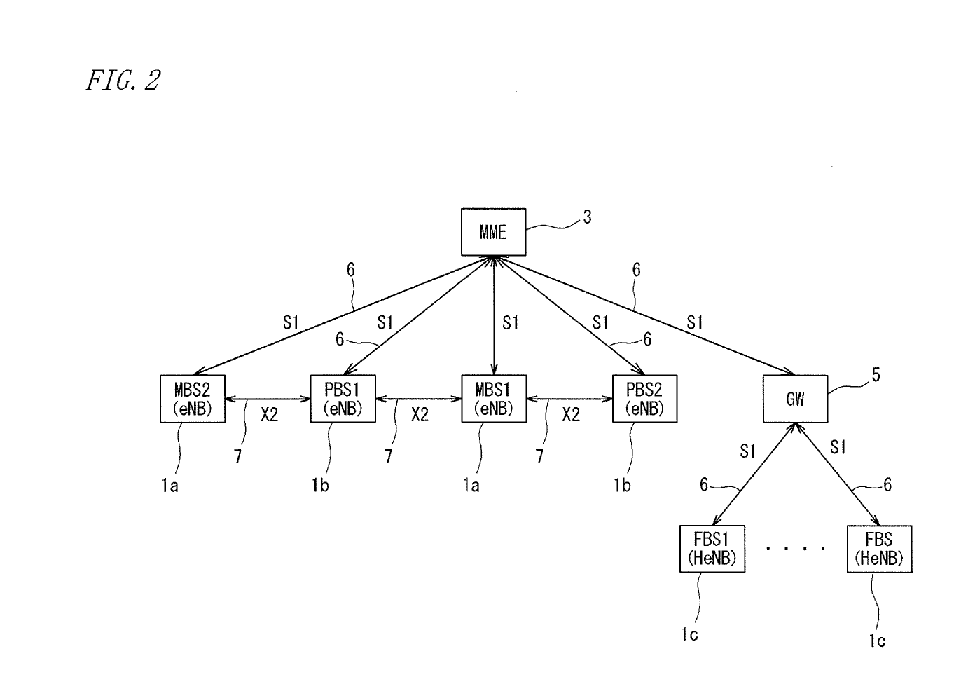

FIG. 2 shows an inter-base-station network (wired network) in which base station devices including macro BSs 1a, pico BSs 1b, and femto BSs 1c (CSG femto BSs or Open femto BSs) are connected. Each macro BS 1a and each pico BS 1b, i.e., each eNB, are connected to an MME (Mobility Management Entity) via a line 6 using a communication interface called “S1 interface”. The MME 3 is a node that manages the positions and the like of terminal devices 2, and performs a process of mobility management for each terminal device 2.

Further, the respective eNBs are connected to each other by a line 7 using a communication interface called “X2 interface”, and are allowed to communicate with each other to directly exchange information. However, in the current standard, the femto BS 1c cannot have the X2 interface.

Connection using the X2 interface is not limited to that shown in FIG. 2, and the X2 interface may be provided between any two eNBs.

Each femto BS 1c (CSG femto BS or Open femto BS) as an HeNB is connected to the MME 3 via an HeNB gateway (GW) 5. Connection between the MME 3 and the gateway 5 and connection between the gateway 5 and the femto BS 1c are also achieved by a line 6 using the communication interface called “S1 interface”.

The femto BS 1c (CSG femto BS or Open femto BS) may be connected to the MME 3 by the S1 interface without an intervening HeNB gateway (GW) 5.

The network using the S1 interface and the X2 interface forms an inter-base-station network in which the respective base station devices 1a, 1b, and 1c are wire-connected. In the inter-base-station network, a server for managing communication (not shown) and the like are installed.

### 2. Frame Structure for LTE

In an FDD scheme that can be adopted in the LTE with which the communication system of the present embodiment complies, uplink communication and downlink communication are simultaneously performed by allocating different operating frequencies to an uplink signal (a transmission signal from a terminal device to a base station device) and a downlink signal (a transmission signal from the base station device to the terminal device).

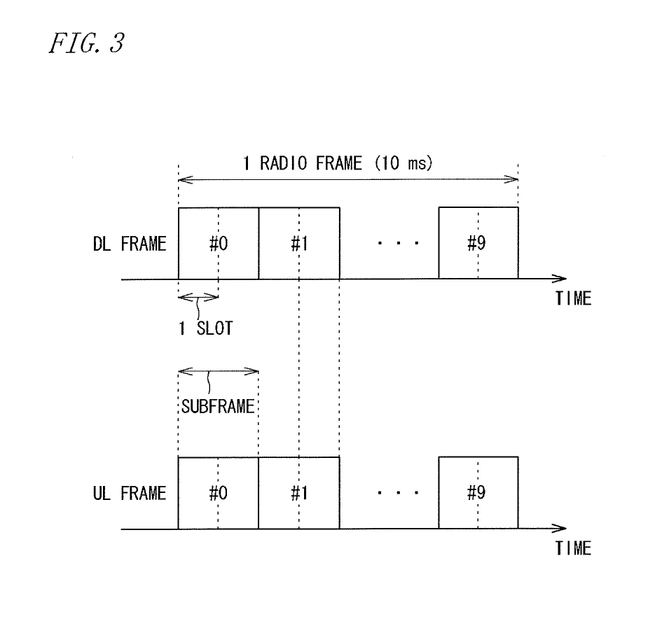

FIG. 3 is a diagram showing the structures of uplink and downlink radio frames for the LTE. Each of a downlink radio frame (DL frame) and an uplink radio frame (UL frame), which are the essential frames for the LTE, has a time length of 10 milliseconds per radio frame, and consists of 10 subframes #0 to #9 (each subframe is a communication unit area having a constant time length). The DL frame and the UL frame are arranged in the time-axis direction with their timings coinciding with each other.

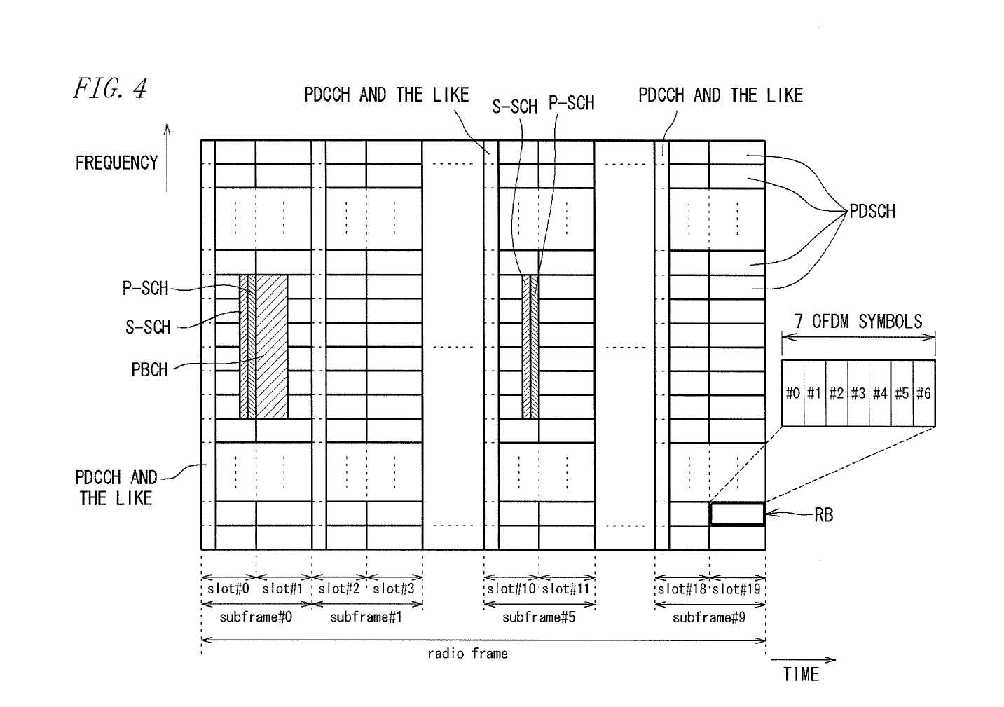

FIG. 4 is a diagram showing the structure of the DL frame (the transmission frame from the base station device) in detail. In FIG. 4, the vertical axis direction indicates the frequency, and the horizontal axis direction indicates the time.

Each of subframes that form the DL frame consists of 2 slots. Each slot consists of 7 (#0 to #6) OFDM symbols (in the case of Normal Cyclic Prefix).

Further, in FIG. 4, a resource block (RB) that is a fundamental unit area for data transmission is defined by 12 subcarriers in the frequency-axis direction and 7 OFDM symbols (1 slot) in the time-axis direction.

Further, for the bandwidth of the DL frame in the frequency direction, a plurality of set values are provided up to the maximum of 20 MHz.

As shown in FIG. 4, at the beginning of each subframe, a transmission area is secured in which a base station device 1 allocates, to a terminal device 2, a control channel required for downlink communication. This transmission area corresponds to symbols #0 to #2 (three symbols at maximum) in the front-side slot in each subframe. Allocated to the transmission area are: a physical downlink control channel (PDCCH) including, for example, allocation information of a physical downlink shared channel (PDSCH, described later) and a physical uplink shared channel (PUSCH, described later), in which user data are stored; a physical control format indicator channel (PCFICH) for notifying information relating to the PDCCH; and a physical hybrid-ARQ indicator channel for transmitting an acknowledgement (ACK) and a negative acknowledgement (NACK) in response to a hybrid automatic repeat request (HARQ) to the PUSCH.

Among the 10 subframes that form the DL frame, the 1st (#0) and 6th (#5) subframes are each given a primary synchronization channel (P-SCH) and a secondary synchronization channel (S-SCH) which are control signals for identifying a base station device or a cell.

The P-SCH is arranged, in the time-axis direction, in the position corresponding to symbol #6 that is the last OFDM symbol in the front-side slot in the subframe #0 so as to have a width corresponding to one symbol, and arranged, in the frequency-axis direction, in the center of the bandwidth of the DL frame so as to have a width corresponding to 6 resource blocks (72 subcarriers).

The S-SCH is arranged, in the time-axis direction, in the position corresponding to symbol #5 that is the second last OFDM symbol in the front-side slot in the subframe #5 so as to have a width corresponding to one symbol, and arranged, in the frequency-axis direction, in the center of the bandwidth of the DL frame so as to have a width corresponding to 6 resource blocks (72 subcarriers).

As described above, each downlink signal is formed by arranging a plurality of subframes, and the plurality of subframes forming the downlink signal include subframes that include the P-SCH and the S-SCH, and subframes that do not include these signals.

The subframes (#0 and #5) including the P-SCH and the S-SCH are arranged at intervals when the downlink signal is viewed in terms of units of subframes. By being arranged in the DL frame as described above, the P-SCH and the S-SCH are periodically arranged in the downlink signal, in a cycle corresponding to ten subframes.

The P-SCH and the S-SCH periodically arranged as described above indicate the transmission timing of each of the subframes forming the radio frame. Therefore, the P-SCH and the S-SCH are used as signals not only for the case where a terminal device achieves synchronization with a base station device but also for inter-base-station synchronization in which synchronization of radio frame transmission timing and/or frequency (clock) is achieved between base station devices.

In the DL frame, a physical broadcast channel (PBCH) is allocated to the first subframe #0. The PBCH notifies, by broadcasting, terminal devices of the frequency bandwidth and the like of the system. The PBCH is arranged, in the time-axis direction, in the position corresponding to symbols #0 to #3 in the rear-side slot in the first subframe #0 so as to have a width corresponding to 4 symbols, and arranged, in the frequency-axis direction, in the center of the bandwidth of the DL frame so as to have a width corresponding to 6 resource blocks (72 subcarriers). The PBCH is configured to be updated every 40 milliseconds by transmitting the same information over 4 frames.

The PBCH has, stored therein, master information blocks (MIB) containing the communication bandwidth, the radio frame number, and the like.

Resource blocks in which the above-described channels are not allocated are used as a physical downlink shared channel (PDSCH) in which user data and the like are stored. The PDSCH is an area shared by a plurality of terminal devices.

Allocation of the user data stored in the PDSCH is notified to terminal devices by means of resource allocation information relating to downlink radio resource allocation, which is stored in the PDCCH allocated at the beginning of each subframe. The resource allocation information is information indicating radio resource allocation to each PDSCH, and allows each terminal device to know whether data directed to the terminal device is stored in the subframe.

The P-SCH, S-SCH, PBCH, PDCCH, and other control channels include various kinds of control signals required by each terminal device 2 to receive the data signal transmitted by the PDSCH. Therefore, if these control channels are subjected to radio wave interference, reception of the data signal transmitted by the PDSCH is adversely affected.

Further, control signals common to the respective terminal devices, control signals specific to the respective terminal devices, and the like are also stored in the PDSCH, in addition to the user data. The control signals stored in the PDSCH include, for example, a system information block (SIB).

The control signals transmitted by the PDCCH, PCFICH, PBCH and the like, and the P-SCH and S-SCH are signals each indicating information necessary for each terminal device connected to the base station device to maintain the connection. Therefore, the terminal device reads these control signals, and maintains wireless connection to the base station device, based on the respective pieces of information.

### 3. Configuration of Base Station Device

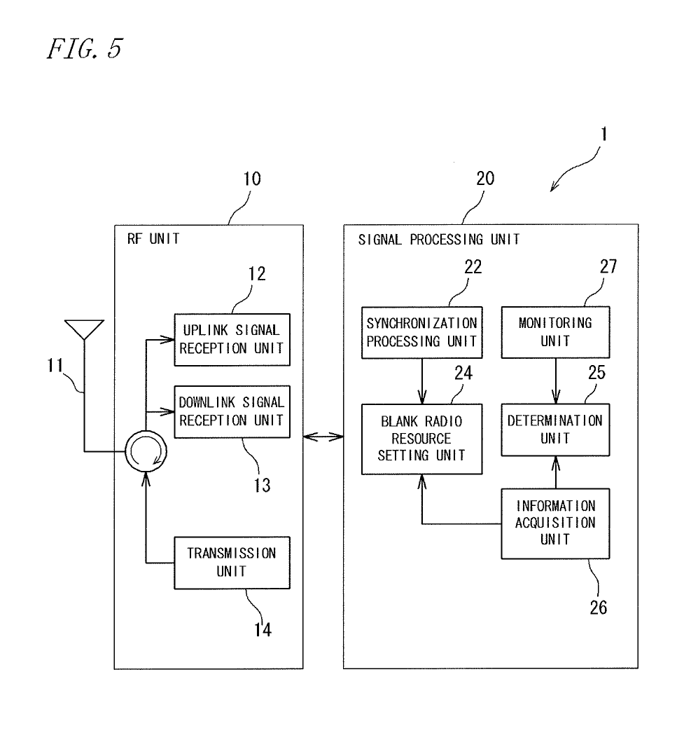

FIG. 5 is a block diagram showing the configuration of a femto BS (CSG femto BS) 1c. The femto BS 1c includes an antenna 11, a transmission/reception unit (RF unit) 10 to which the antenna 11 is connected, and a signal processing unit 20 which performs processing of signals transmitted and received by the RF unit 10, and the like.

The RF unit 10 includes an uplink signal reception unit 12, a downlink signal reception unit 13, and a transmission unit 14. The uplink signal reception unit 12 receives an uplink signal from a terminal device 2. The downlink signal reception unit 13 receives a downlink signal from another base station device 1. The transmission unit 14 transmits a downlink signal to the terminal device 2.

The downlink signal received by the downlink signal reception unit 13 is provided to the signal processing unit 20, and processed by a synchronization processing unit 22 or a demodulation unit (not shown).

The signal processing unit 20 includes a synchronization processing unit 22, a blank radio resource setting unit (blank section setting unit) 24, a determination unit 25, an information acquisition unit 26, and a monitoring unit 27.

The synchronization processing unit 22 performs a synchronization process including: acquiring a downlink signal of another base station device 1 (e.g., the macro BS 1a), which has been received by the downlink signal reception unit 13; and achieving inter-base-station synchronization such that the transmission timing of each subframe in the radio frame of the femto BS 1c coincides with that of the another base station device 1, based on a P-SCH and an S-SCH that are known signals included in the downlink signal of the another base station device 1. In the synchronization process, synchronization may be achieved such that the transmission timing of each subframe in the radio frame of the femto BS 1c is shifted by a desired time relative to that of the another base station device 1.

Since the pico BS 1b and, if necessary, the macro BS 1a have the inter-base-station synchronization function, it is possible to achieve inter-base-station synchronization among all the base station devices 1a, 1b, and 1c in the same macro cell MC.

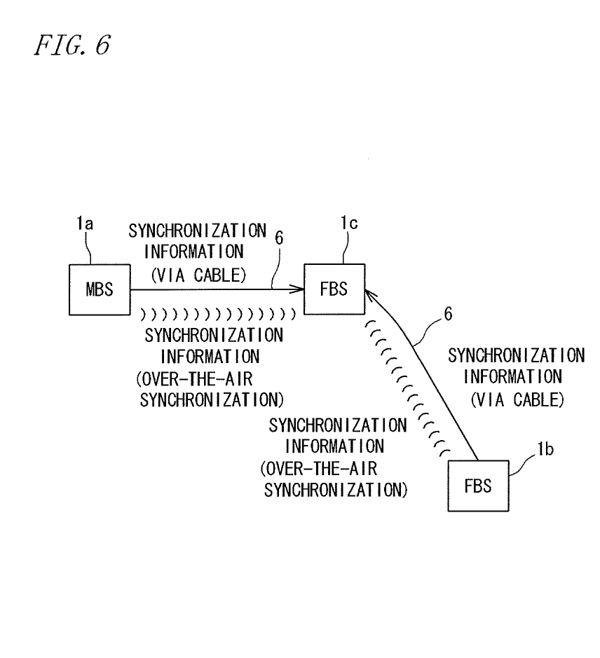

As shown in FIG. 6, the inter-base-station synchronization may be achieved by exchanging information for the inter-base-station synchronization between the base station devices via the inter-base-station network 6 or 7, or by performing “over-the-air synchronization” in which synchronization is achieved by using the radio signal (downlink signal) transmitted by the another base station device 1a. Alternatively, the respective base station devices 1 may have GPS receivers to achieve synchronization by means of GPS signals.

In the case of achieving inter-base-station synchronization by over-the-air synchronization, the synchronization processing unit 22 determines to perform the synchronization process, when the femto BS 1c is activated, or periodically, or according to an external instruction. Then, the synchronization processing unit 22 causes the transmission unit 14 to suspend transmission of the downlink signal of the femto BS 1c, and acquires the downlink signal of the another base station device 1, which has been received by the downlink signal reception unit 13.

The synchronization processing unit 22 detects the periodically arranged P-SCH and S-SCH which are included in the downlink signal of the another base station device 1, and acquires the transmission timing, frequency, and the like of the subframe in the radio frame in the another base station device 1.

Further, the synchronization processing unit 22 detects a synchronization error, based on the acquired transmission timing and frequency of the subframe in the downlink signal of the another base station device 1, and adjusts the subframe transmission timing and the subframe length of the femto BS 1b so as to coincide with those of the another base station device 1, thereby achieving synchronization.

The synchronization processing unit 22 performs the inter-base-station synchronization process with the macro BS 1a, and thereby comprehends the transmission timing of the subframe in which the control signals to be protected, such as the P-SCH, S-SCH, and PBCH, in the DL frame transmitted by the macro BS 1a.

Upon acquiring the transmission timing of the subframe in the DL frame transmitted by the macro BS 1a, in which the control signals to be protected, such as the P-SCH, S-SCH, and PBCH, are contained, the synchronization processing unit 22 notifies the blank section setting unit 24 (refer to FIG. 5) of the transmission timing. The transmission timing of the subframe transmitted by the macro BS 1a, in which the control signals to be protected, such as the P-SCH, S-SCH, and PBCH, are contained, may be acquired by the information acquisition unit 26 via the inter-base-station network 6 or 7.

The blank radio resource setting unit 24 sets a radio resource to be blank, in a radio resource (time resource or frequency resource) that the femto BS 1c can use. In the present embodiment, the blank radio resource setting unit 24 functions as a blank section setting unit which sets one or a plurality of subframes in the DL frame transmitted by the femto BS 1c, as a blank subframe (blank section).

The blank section setting unit 24 adjusts the position where the blank subframe is to be set so as to avoid as much as possible interference to the cell formed by the another base station device.

Further, the blank section setting unit 24 adjusts the position where the blank subframe is to be set, based on the position of a blank subframe in the another base station device.

Furthermore, the blank section setting unit 24 adjusts the position where the blank subframe is to be set, based on whether a pico BS 1b is present in the neighborhood of the femto BS 1c.

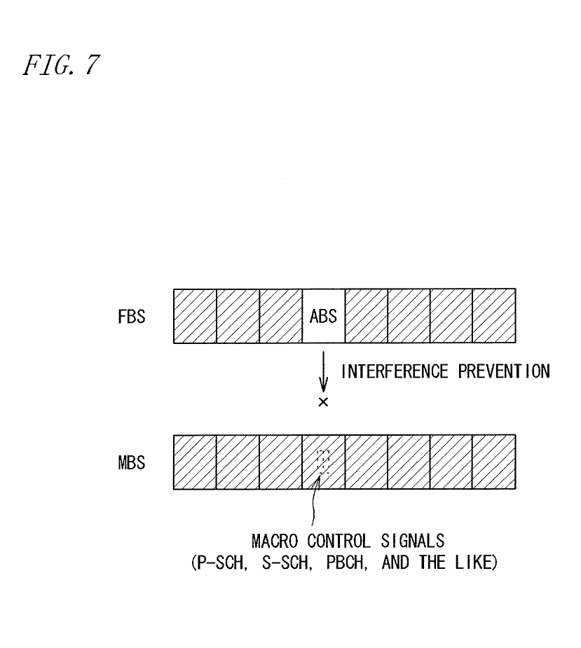

In FIG. 1, if only interference between the femto BS 1c and the macro BS 1b is considered without regard to the pico BS 1b, the blank section setting unit 24 sets, as a blank subframe, a subframe in the DL frame of the femto BS 1c, which corresponds to the transmission timing (transmission section) of the control signals transmitted by the macro BS 1a, as shown in FIG. 7.

The blank subframe need not be set in the positions corresponding to all the control signals transmitted by the macro BS 1a. It is sufficient that the blank subframe is set in the positions corresponding to the control signals to be protected among the control signals transmitted by the macro BS 1a.

The blank subframe is a subframe which substantially contains no data signal, and during which a null signal is transmitted. Therefore, a terminal device 2 connected to the macro BS 1a (hereinafter referred to as “macro terminal”) is suppressed from being subjected to radio wave interference from the femto BS 1c, when receiving the control signals (P-SCH, S-SCH, PBCH, and the like) transmitted by the macro BS 1a.

That is, in the femto cell FC, because of the terminal access limitation by the femto BS 1c, a general terminal device 2 having no access right to the femto BS 1c cannot access the femto BS 1c. That is, the terminal device 2, even when it is present in the femto cell FC, is preferentially connected to the macro BS 1a over the femto BS 1c, and becomes a macro terminal. Accordingly, the macro terminal might be subjected to strong radio wave interference from the femto BS 1c, and cannot receive even the control signals (hereinafter referred to as “macro control signals”) from the macro BS 1a.

In contrast, if the femto BS 1c sets the blank subframe in the frame position corresponding to the macro control signals desired to be protected, the macro terminal can receive the macro control signals.

In the present embodiment, the blank section setting unit 24 adopts an ABS (Almost Blank Subframe) as the blank subframe (blank section). The ABS is a blank subframe which contains no data signal (PDSCH), but contains a reference signal (CRS; Cell-specific Reference Signal) and/or other minimum necessary control signals.

Further, even a subframe which contains a data signal and is used for communication may be used as a blank subframe if the signal power of the subframe is reduced and the subframe is regarded as a blank subframe that is not substantially used when being sufficiently apart from the base station device.

The blank subframe (blank section) is not limited to the ABS. A subframe (MBSFN) for MBMS (Multimedia Broadcast Multicast Service) may be used. The MBMS is a broadcast service such as a TV broadcast service, in which a plurality of base station devices broadcast the same information by using the same resource at the same timing.

Since the MBMS is a broadcast service, in the MBSFN subframe, information relating to the MBMS, and minimum necessary control information indicating that the corresponding subframe is an MBSFN subframe are broadcast by using the control channel (two symbols at the beginning of the subframe), but control information directed to a specific terminal device is not transmitted.

In the present embodiment, in order to make the MBSFN subframe blank, a null signal is set as a data signal in the MBSFN subframe to be transmitted by the femto BS 1c. Since the MBSFN subframe for transmitting the null signal need not include a reference signal, it is closer to a perfect blank subframe than the ABS.

As described above, the blank subframe (blank section) need not be a subframe containing no signal at all, but may be a subframe in which a blank of a signal substantially exist.

Further, the radio resource in which a blank radio resource is set may be a frequency resource. For example, among frequencies (carriers) that a base station device can use, a frequency not to be used (blank carrier) may be secured. By setting, as a frequency not to be used (blank carrier), a frequency (carrier) that is used by another cell not to be interfered with, it is possible to avoid interference to the another cell. Although the following description will be given of a case where a subframe that is a time resource is adopted as an example of a radio resource, the following description is also applicable to a case where the radio resource is a frequency (carrier). That is, the blank radio resource setting unit 24 may function as a blank carrier setting unit.

As shown in FIG. 7, in the relationship between the macro BS 1a and the femto BS 1c, the control signals of the macro BS 1a as a public base station device should be protected, and a blank subframe is set in the transmission frame of the femto BS 1c that is privately used. The reason is because the general terminal device 2 is not connected to the privately used femto BS 1c but preferentially connected to the macro BS 1a that is a public base station device.

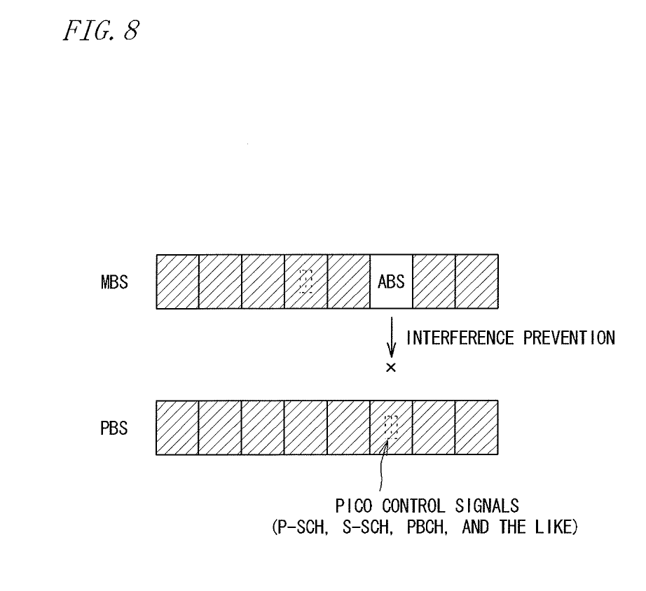

On the other hand, in the relationship between the macro BS 1a and the pico BS 1b that are both public base station devices, priority is given to protection of the control signals of the pico BS 1b in the present embodiment. Accordingly, as shown in FIG. 8, a blank subframe (blank section) is set in the transmission frame of the macro BS 1a.

The reason why protection of the control signals of the pico BS 1b is given priority over the macro BS 1a in the present embodiment is based on the viewpoint that as many macro terminals in the macro cell MC as possible are gathered in the pico cell PC to reduce the load on the macro BS 1a. In this viewpoint, it is desired that the terminal device 2 is connected not to the macro BS 1a but to the pico BS 1b. That is, the terminal device 2 is preferentially connected to the pico BS 1b over the macro BS 1a. Accordingly, protection of the control signals of the pico BS 1b (pico control signals) is important.

The macro BS 1a which sets the blank subframe acquires the synchronization information and/or the control signal transmission timing information of the pico BS 1b, via the inter-base-station network (X2 interface), like the femto BS 1c. Then, the blank section setting unit 24 of the macro BS 1a sets the blank subframe in the frame position corresponding to the pico control signals desired to be protected. Thereby, the terminal device 2 can reliably receive the pico control signals.

As described above, when the presence of the pico BS 1b is not considered, the blank section setting unit 24 of the femto BS 1c sets the blank subframe so as to protect the macro control signals, as shown in FIG. 7.

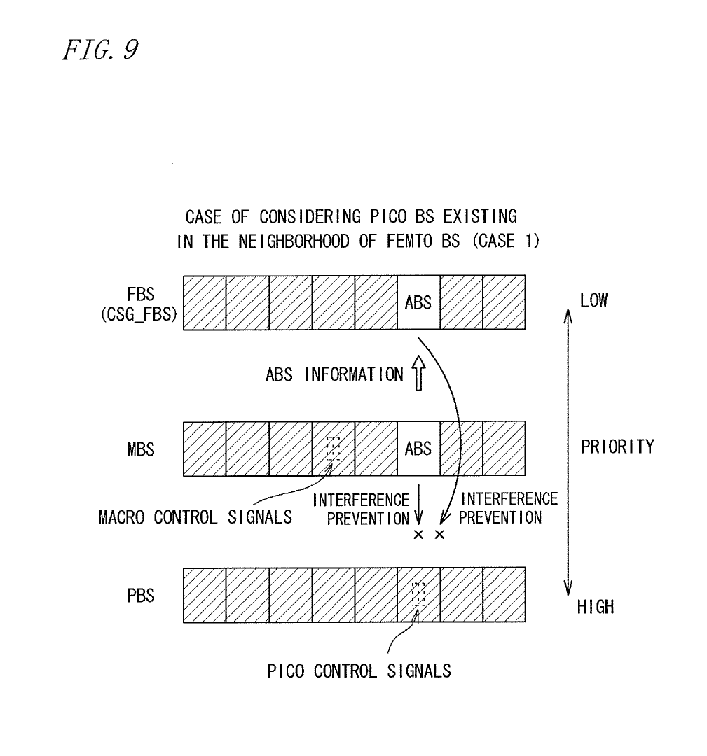

In contrast, when the presence of the pico BS 1b located in the neighborhood of the femto BS 1c is considered, the blank section setting unit 24 of the femto BS 1c sets the blank subframe such as an ABS, not in the frame position corresponding to the macro control signals but in the frame position corresponding to the pico control signals, as shown in FIG. 9.

Thereby, the pico control signals are protected by the blank subframe (ABS) of the femto BS 1c. Further, the blank section setting unit 24 of the macro BS 1a also sets a blank subframe such as an ABS in the frame position corresponding to the pico control signals, as in the femto BS 1c.

As shown in FIG. 9, the positions of the blank subframes set by the macro BS 1a and the femto BS 1c are the same. Therefore, the femto BS 1c can protect the pico control signals by setting the blank subframe in the position corresponding to the position of the blank subframe (blank section) in the macro BS 1a. That is, the femto BS 1c determines the position of the blank subframe in the femto BS 1c in accordance with the position of the blank subframe set by the macro BS 1a.

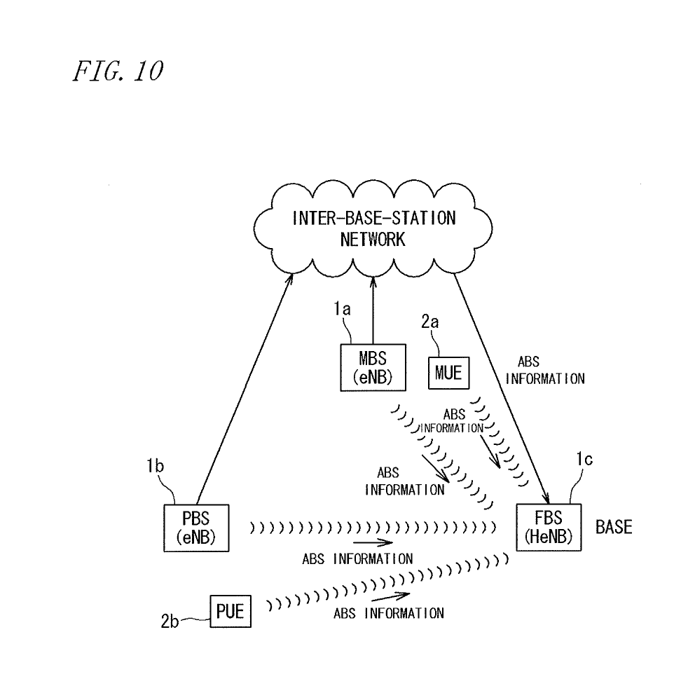

As shown in FIG. 10, there are several variations of routes through which the femto BS 1c comprehends the position of the blank subframe (ABS and/or MBSFN or the like) in the transmission frame of the macro BS 1a. For example, the information acquisition unit 26 of the femto BS 1c can acquire information (“ABS information” in FIG. 10) indicating the position of the blank subframe (blank radio resource) from the macro BS 1a via the inter-base-station network such as X2 or S1. When the blank radio resource is the frequency resource, the information acquisition unit 26 acquires information indicating the position of the blank frequency (blank carrier) among the usable frequencies.

The information acquisition unit 26 of the femto BS 1c may wirelessly acquire the ABS information from the macro BS 1a, or wirelessly acquire the ABS information from a macro terminal 2a that has acquired the ABS information from the macro BS 1a.

Further, the femto BS 1c may acquire the ABS information of the macro BS 1a (macro ABS information), via the inter-base-station network or wirelessly, from the pico BS 1b that has acquired the ABS information from the macro BS 1a via the inter-base-station network. Furthermore, the femto BS 1c may wirelessly acquire the macro ABS information from a pico terminal 2b that has acquired the macro ABS information from the pico BS 1b.

The femto BS 1c may acquire the positions of the macro control signals and/or the pico control signals through the routes shown in FIG. 10.

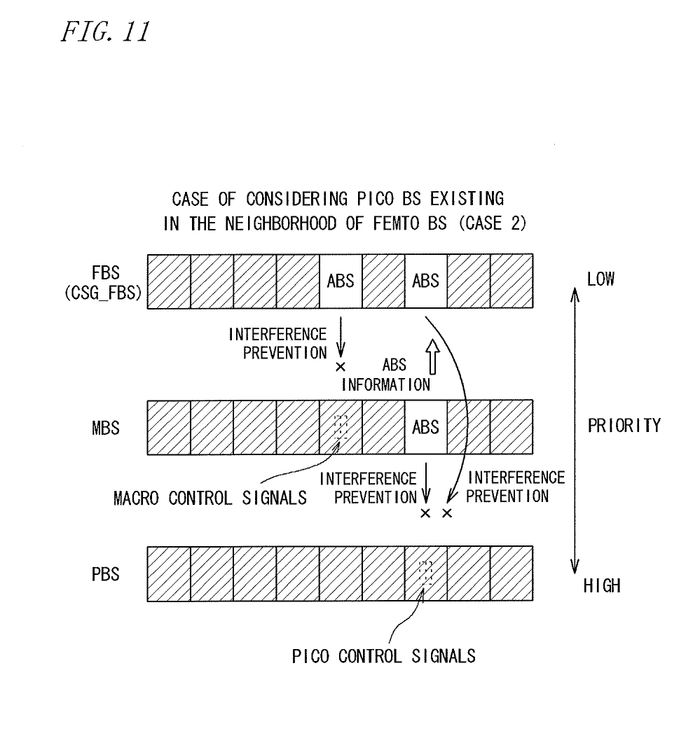

FIG. 11 shows another example of the blank subframe (ABS) setting manner in a case where the pico BS 1b located in the neighborhood of the femto BS 1c is considered. In FIG. 11, the blank section setting unit 24 of the femto BS 1c sets blank subframes so as to protect both the pico control signal and the macro control signal.

That is, the femto BS 1c sets a blank subframe in accordance with the position of the blank subframe in the macro BS 1a, and additionally sets a blank subframe for preventing interference to the macro cell MC.

The manner shown in FIG. 11 is advantageous over the manner shown in FIG. 9 in that both the pico control signals and the macro control signals are protected.

On the other hand, in the case of FIG. 11, the percentage of the blank subframes in the frame transmitted by the femto BS 1c increases, which causes limitation on communication in the femto cell FC. Regarding this point, the manner shown in FIG. 9 is advantageous because the percentage of the blank subframes in the frame transmitted by the femto BS 1c is relatively low.

[3.1 Determination Based on Transmission Power]

Determination as to whether a pico BS 1b is present in the neighborhood the femto BS 1c is performed by the determination unit 25 (refer to FIG. 5) of the femto BS 1c.

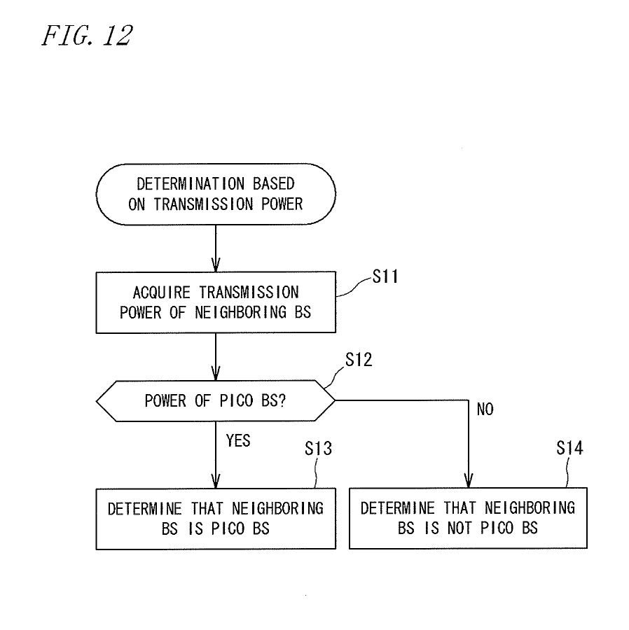

FIG. 12 shows a determination method using a transmission power. The method adopts, for the determination, a DL power parameter (transmission power information; DL transmission power limitation value) included in a DL frame transmitted from a base station device in the neighborhood of the femto BS 1c. The magnitude of a DL transmission power defines a cell diameter, and the cell diameter varies among a macro cell MC, a pico cell PC, and a femto cell FC (macro cell diameter>pico cell diameter>femto cell diameter). In the LTE, Reference Signal Power (magnitude of power of a reference signal) in SIB2 (System Information Block Type 2) message can be used as a DL power parameter.

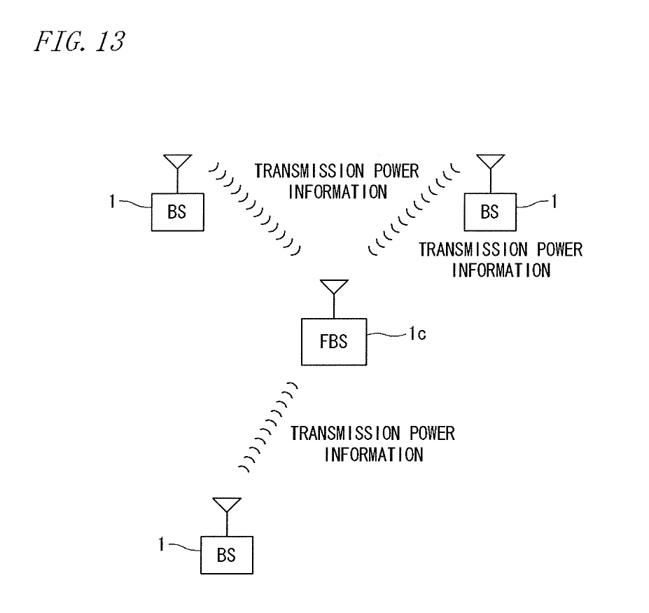

When using the DL power parameter for the determination of presence/absence of a pico BS 1b, the femto BS 1c sniffs DL frames transmitted from neighboring other base station devices as shown in FIG. 13. Then, the information acquisition unit 26 of the femto BS 1c acquires DL power parameters (transmission power information) contained in the DL frames transmitted from the respective base station devices in the neighborhood of the femto BS 1c (step S11). The determination unit 25 determines whether the transmission power value indicated by each of the acquired DL power parameters is a transmission power value set for a pico BS 1b, or whether the transmission power value is within a predetermined transmission power range set for a pico BS 1b, thereby determining whether a pico BS 1b is present in the neighborhood of the femto BS 1c (step S12).

When it has been determined that a pico BS 1b is present in the neighborhood of the femto BS 1c, the setting unit 24 sets a position of a blank section such as an ABS so as to protect the pico control signals as shown in FIG. 9 (step S13). That is, based on the ABS information acquired from the macro BS 1a, the femto BS 1c sets an ABS in the same position as the ABS in the macro BS 1a. Further, if necessary, the setting unit 24 sets a position of a blank section such as an ABS so as to also protect macro control signals as shown in FIG. 11.

When it has been determined that no pico BS 1b is present in the neighborhood of the femto BS 1c, the setting unit 24 sets a position of a blank section such as an ABS so as to protect the macro control signals without considering protection of the pico control signals, as shown in FIG. 7 (step S14). That is, the femto BS 1c performs the setting of the blank position without considering the ABS information acquired from the macro BS 1a.

[3.2 Determination Based on Cell ID]

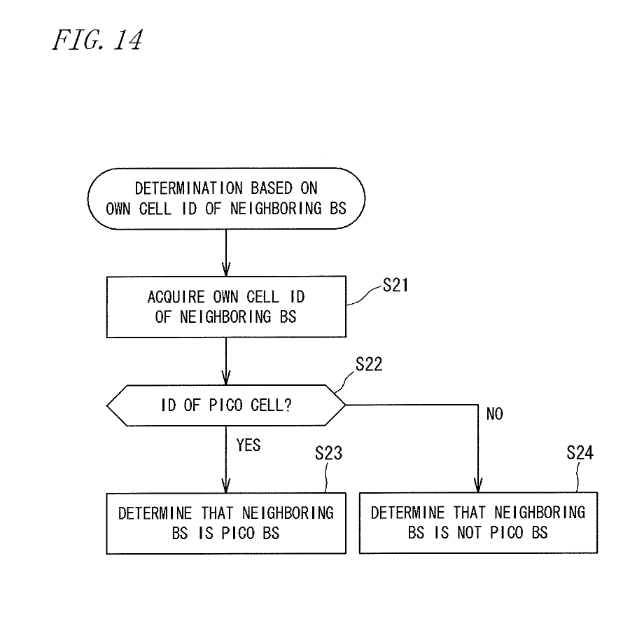

FIG. 14 shows how the determination unit 25 performs determination as to whether a pico BS 1b is present in the neighborhood of the femto BS 1c, based on cell IDs of neighboring base station devices 1 (base station device IDs).

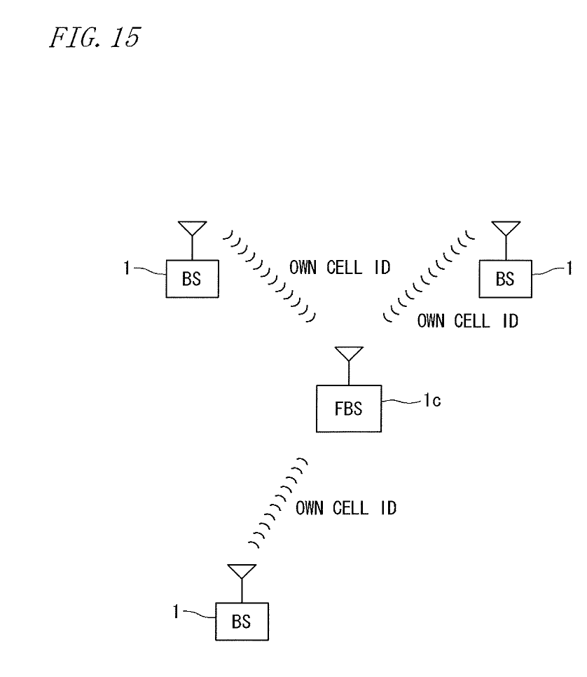

When using the cell IDs for the determination of presence/absence of a pico BS 1b, the femto BS 1c sniffs DL frames transmitted from neighboring other base station devices as shown in FIG. 15. Then, the information acquisition unit 26 of the femto BS 1c acquires cell IDs contained in the DL frames transmitted from the respective base station devices in the neighborhood of the femto BS 1c (step S21). The cell ID described here is a cell ID owned by the base station device that has transmitted the DL frame (own cell ID). In the LTE, the own cell ID is contained in the SIB1 (System Information Block Type 1) as broadcast Information to terminal devices 2.

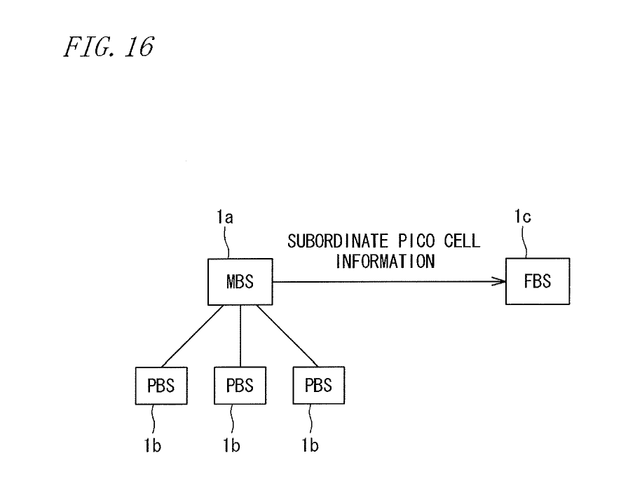

The macro BS 1a knows the cell IDs of subordinate pico BSs 1b in the macro cell MC formed by the macro BS 1a, and the cell IDs of the subordinate pico BSs 1b of the macro BS 1a (subordinate pico cell information) are notified to the femto BS 1c via an inter-base-station network or wirelessly as shown in FIG. 16. The information acquisition unit 26 of the femto BS 1c acquires the cell IDs of the pico BSs 1b notified from the macro BS 1a.

The determination unit 25 compares the cell IDs acquired in step S21 with the cell IDs of the pico BSs 1b notified from the macro BS 1a to determine whether a pico BS 1b is present in the neighborhood of the femto BS 1c (step S22). The fact that the femto BS 1c has received a DL frame from another base station device means that the another base station device is present so close to the femto BS 1c that radio wave interference causes a problem. Accordingly, if the another base station device whose DL frame has been received by the femto BS 1c is a pico BS 1b, it means that the pico BS 1b is present in the neighborhood of the femto BS 1c.

When the result of the determination in step S22 is that a pico BS 1b is present in the neighborhood of the femto BS 1c, the setting unit 24 sets a position of a blank section such as an ABS so as to protect the pico control signals as shown in FIG. 9 (step S23). That is, the femto BS 1c sets an ABS in the same position as the ABS in the macro BS 1a, based on the ABS information acquired from the macro BS 1a. Further, if necessary, the setting unit 24 sets a position of a blank section such as an ABS so as to also protect the macro control signals as shown in FIG. 11.

When it has been determined that no pico BS 1b is present in the neighborhood of the femto BS 1c, the setting unit 24 sets a position of a blank section such as an ABS so as to protect the macro control signals without considering protection of the pico control signals, as shown in FIG. 7 (step S24). That is, the femto BS 1c performs setting of the blank position without considering the ABS information acquired from the macro BS 1a.

[3.3 Determination Based on Cell Type]

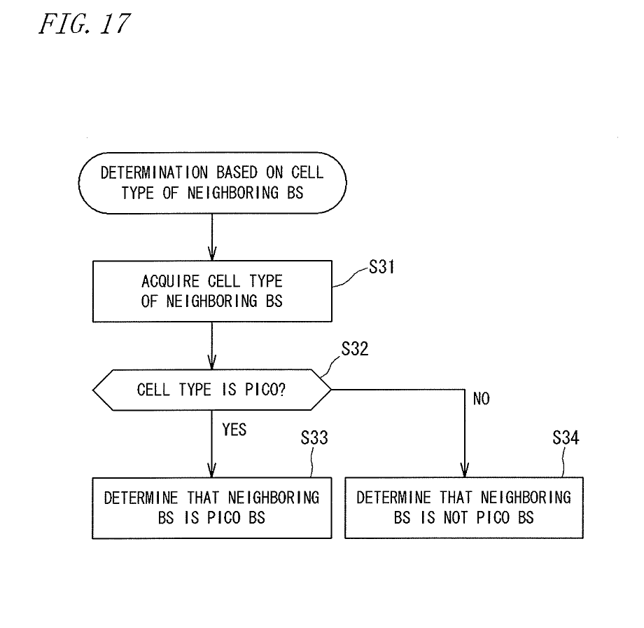

FIG. 17 shows how the determination unit 25 performs determination as to whether a pico BS 1b is present in the neighborhood of the femto BS 1c, based on cell types of neighboring base station devices (information indicating that a base station device is a pico BS b).

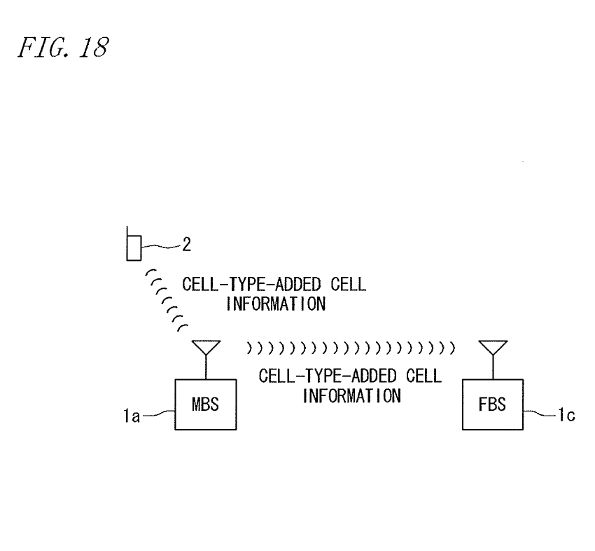

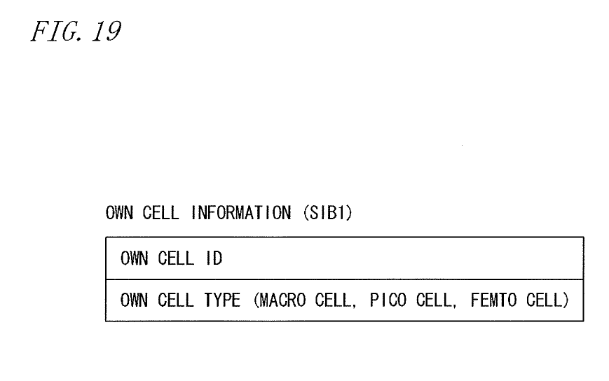

When using the cell types for the determination of presence/absence of a pico BS 1b, the femto BS 1c sniffs DL frames transmitted from neighboring other base station devices as shown in FIG. 18. Then, the information acquisition unit 26 of the femto BS 1c acquires cell-type-added cell information contained in each of the DL frames transmitted from the respective base station devices in the neighborhood of the femto BS 1c (step S31). The cell-type-added cell information is own cell information relating to the base station device that has transmitted the DL frame, and includes an own cell ID and an own cell type as shown in FIG. 19.

The own cell ID is an ID which identifies the base station device that has transmitted the DL frame, and the own cell type is information indicating the type (macro, pico, or femto) of the base station device that has transmitted the DL frame. The receiving end that has received the own cell type is allowed to know the type of the base station device that has transmitted the DL frame, based on the own cell type. The information indicating the base station device type may be information distinguishing between an Open femto and a CSG femto.

In the current LTE standard, the information relating to the own cell is basically contained in System Information Block Type 1 (SIB1). Since the SIB1 is system information to be acquired first after acquisition of Master Information Block (MIB), the SIB1 can be acquired in the initial stage of the cell selection process. Therefore, it is preferable that the own cell type is set in the SIB1.

In the present embodiment, since the cell types are included as the own cell information (broadcast information) to be broadcast to terminal devices 2, each terminal device 2 is allowed to know the cell type (base station device type) of the access destination, and perform a process according to the cell type.

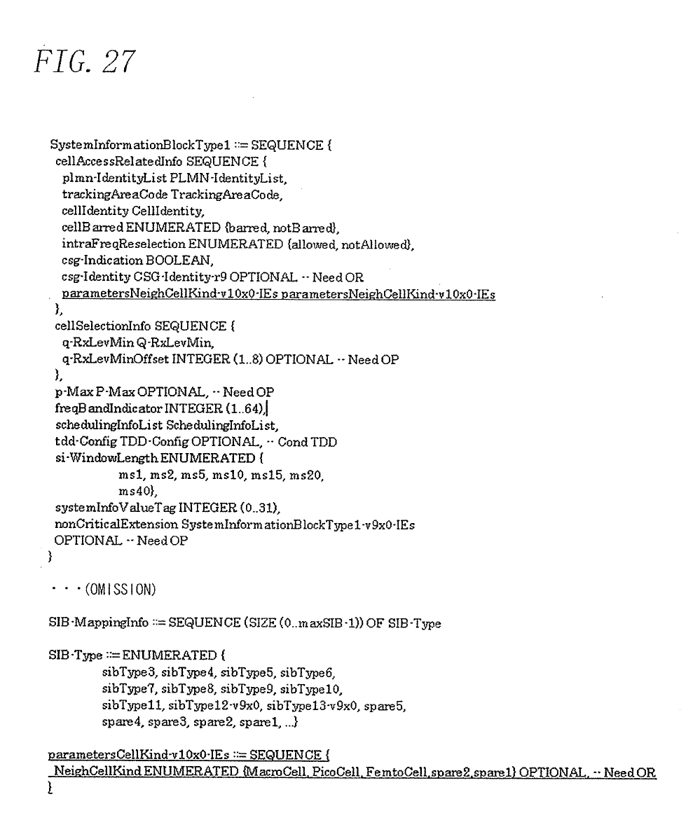

FIG. 27 shows a specific example in which the cell type information is added to the own cell information of the SIB1 (an underlined portion in FIG. 27 corresponds to an additional portion relating to the cell type information).

The determination unit 25 checks whether each of the cell types acquired in step S31 is a pico cell (pico BS) (checks whether information indicating that the corresponding base station device is a pico cell is included) to determine whether a pico BS 1b is present in the neighborhood of the femto BS 1c (step S32). The fact that the femto BS 1c has received a DL frame from another base station device means that the another base station device is present so close to the femto BS 1c that radio wave interference causes a problem. Accordingly, if the another base station device whose DL frame has been received by the femto BS 1c is a pico cell (pico BS), it means that the pico BS 1b is present in the neighborhood of the femto BS 1c.

When the result of the determination in step S32 is that a pico BS 1b is present in the neighborhood of the femto BS 1c, the setting unit 24 sets a position of a blank section such as an ABS so as to protect the pico control signals as shown in FIG. 9 (step S33). That is, the femto BS 1c sets an ABS in the same position as the ABS in the macro BS 1a, based on the ABS information acquired from the macro BS 1a. Further, if necessary, the setting unit 24 sets a position of a blank section such as an ABS so as to also protect the macro control signals as shown in FIG. 11.

When it has been determined that no pico BS 1b is present in the neighborhood of the femto BS 1c, the setting unit 24 sets a position of a blank section such as an ABS so as to protect the macro control signals without considering protection of the pico control signals, as shown in FIG. 7 (step S34). That is, the femto BS 1c performs setting of the blank position without considering the ABS information acquired from the macro BS 1a.

[3.4 Determination Based on Neighboring Base Station List]

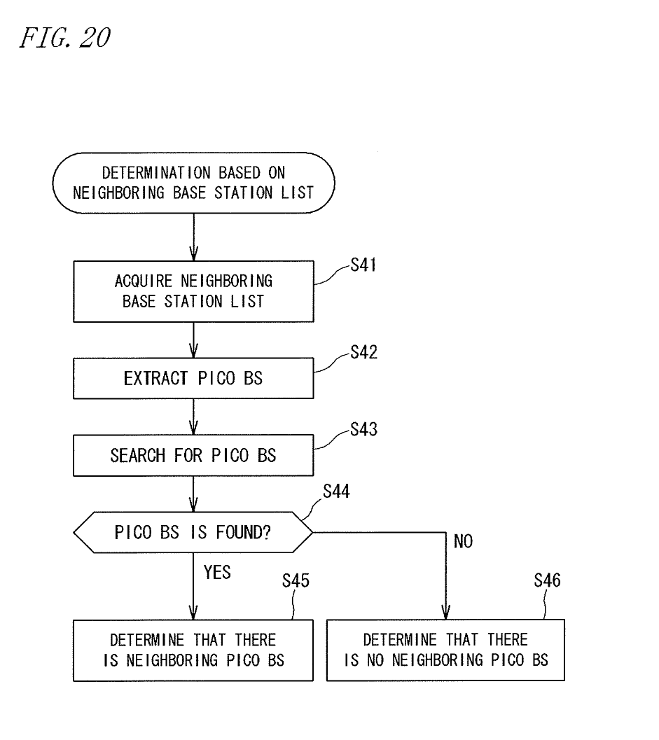

FIG. 20 shows how the determination unit 25 determines whether a pico BS 1b is present in the neighborhood of the femto BS 1c, based on neighboring base station lists transmitted by neighboring base station devices 1.

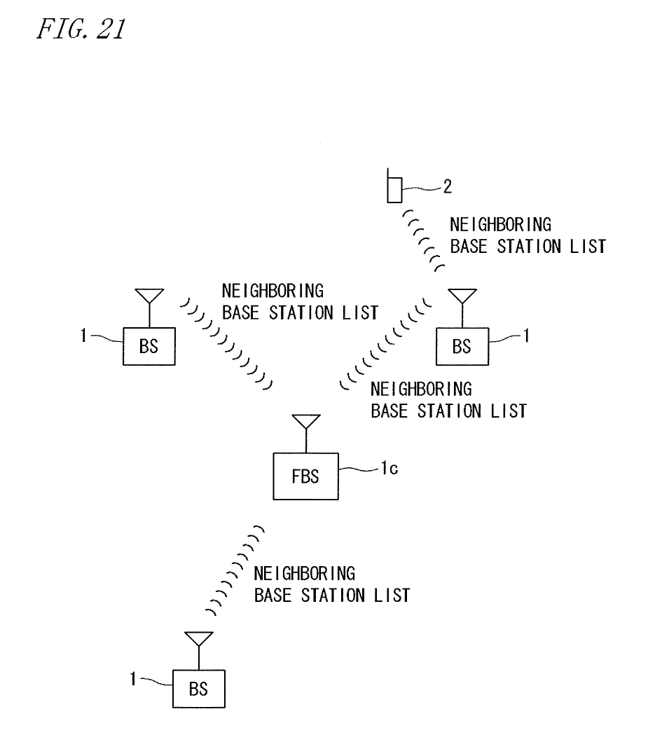

When using the neighboring base station lists for determination of presence/absence of a pico BS 1b, the femto BS 1c sniffs DL frames transmitted from neighboring other base station devices as shown in FIG. 21. Then, the information acquisition unit 26 of the femto BS 1c acquires the neighboring base station lists contained in the DL frames transmitted from the respective base station devices in the neighborhood of the femto BS 1c (step S41).

The neighboring base station list is a list of base station devices 1 that are present in the neighborhood of the base station device 1 that has transmitted the DL frame (list of neighboring base stations (cells) of the same frequency). In the LTE, the neighboring base station list is contained in System Information Block Type 4 (SIB4), and broadcast to terminal devices. By adding information (IE) for identifying the cell type to the neighboring base station list, it is possible to previously notify (by broadcasting) the terminal devices that the neighboring base station is a pico BS.

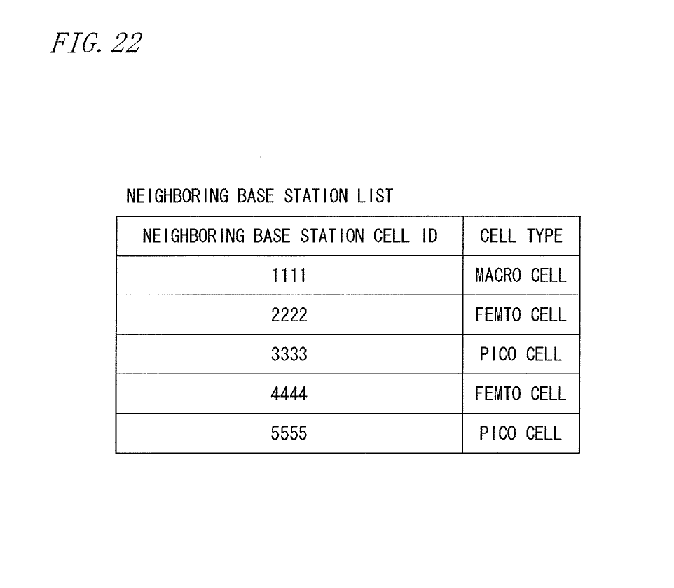

That is, as shown in FIG. 22, the neighboring base station list of the present embodiment includes: neighboring base station cell IDs (neighboring base station device IDs) indicating the neighboring base station devices 1 (cells); and information indicating the cell types (base station device types) of the corresponding neighboring base station cells.

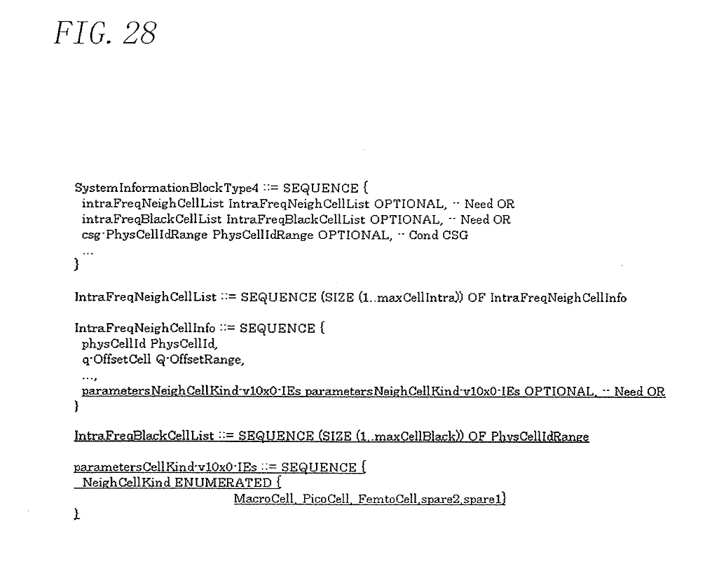

FIG. 28 shows a specific example in which the cell type information is added to the neighboring base station list contained in the SIB4 (an underlined portion in FIG. 28 corresponds to the additional portion relating to the cell type information).

In the present embodiment, since the cell types are contained in the neighboring base station list that is broadcast to the terminal devices 2, each terminal device 2 is allowed to perform a process according to the cell type (base station device type) of the access destination. More specifically, the terminal device 2, which is in the communication idle state (standby mode of a cellular phone) or the like, can perform a process of selecting a pico BS in the neighboring base station list preferentially (over a macro BS) as a base station device 1 to be an access destination.

The femto BS 1c extracts, from the neighboring base station list acquired in step S41, neighboring cells whose cell type is “pico cell” (neighboring pico BSs) (step S42). That is, the femto BS 1c determines whether information indicating that neighboring cells are pico cells is included in the neighboring base station list.

When neighboring pico BSs have been extracted in step S42, the determination unit 25 of the femto BS 1c can determine that pico BSs 1b are present in the neighborhood of the femto BS 1c. However, in the stage of step S42, it has just been determined that the neighboring BSs in the neighborhood of a neighboring BS of the femto BS 1c are pico BSs 1b.

So, in order to perform more reliable determination, the femto BS 1c attempts to detect a radio wave (a DL frame) from each of the neighboring pico BSs extracted in step S42 (pico BS search; step S43). The pico BS search is performed by measuring the radio wave of the DL frame in which the neighboring pico cell ID extracted in step S42 is stored as the own cell ID.

When the radio wave of the DL frame in which the cell ID of the neighboring pico cell extracted in step S42 is stored as the own cell ID has been detected, or when the intensity of the radio wave is not lower than a predetermined threshold, the determination unit 25 determines that a pico BS 1b is present in the neighborhood of the femto BS 1c (step S44).

When the result of the determination in step S44 is that a pico BS 1b is present in the neighborhood of the femto BS 1c, the setting unit 24 sets a position of a blank section such as an ABS so as to protect the pico control signals as shown in FIG. 9 (step S33). That is, based on the ABS information acquired from the macro BS 1a, the femto BS 1c sets an ABS in the same position as the ABS in the macro BS 1a. Further, if necessary, the setting unit 24 sets a position of a blank section such as an ABS so as to also protect the macro control signals as shown in FIG. 11.

When it has been determined that no pico BS 1b is present in the neighborhood of the femto BS 1c, the setting unit 24 sets a position of a blank section such as an ABS so as to protect the macro control signals without considering protection of the pico control signals as shown in FIG. 7 (step S34). That is, the femto BS 1c performs setting of the blank position without considering the ABS information acquired from the macro BS 1a.

[3.5 Determination Based on Presence/Absence of Cell Range Expansion]

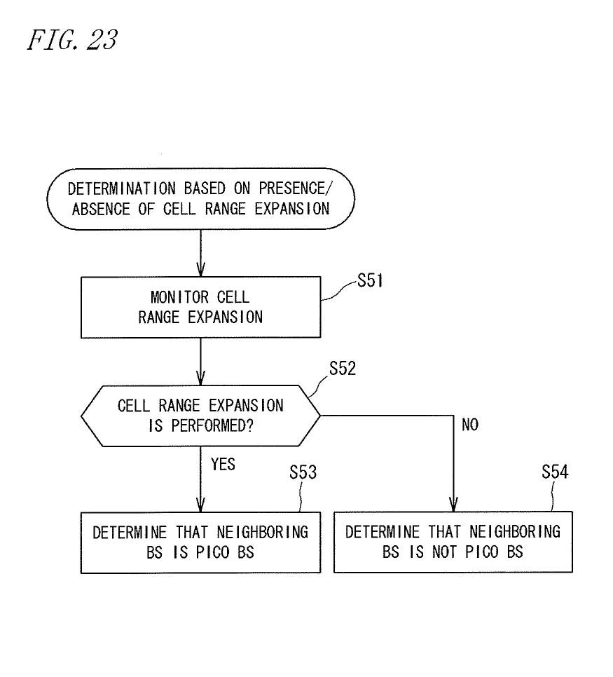

FIG. 23 shows how the determination unit 25 performs determination as to whether a pico BS 1b is present in the neighborhood of the femto BS 1c, based on presence/absence of cell range expansion. Cell range expansion (RE) is a process in which a base station device expands its own cell so as to accommodate more terminal devices in the own cell. Since a pico BS 1b performs cell range expansion, if there is a neighboring BS that performs range expansion, it is determined that a pico BS 1b is present in the neighborhood of the femto BS 1c.

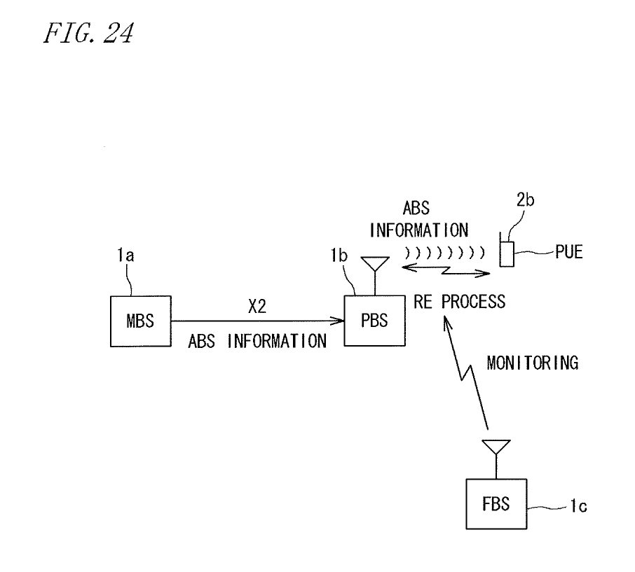

In order to monitor cell range expansion, the monitoring unit 27 of the femto BS 1c sniffs a DL frame or a UL frame transmitted from neighboring another base station device as shown in FIG. 24 (step S51). If it is detected that the another base station device and a terminal device exchange a message for cell range expansion, it is possible to determine that a pico BS 1b is present in the neighborhood of the femto BS 1c (step S52).

When the result of the determination in step S52 is that a pico BS 1b is present in the neighborhood of the femto BS 1c, the setting unit 24 sets a position of a blank section such as an ABS so as to protect the pico control signals as shown in FIG. 9 (step 533). That is, the femto BS 1c sets an ABS in the same position as the ABS in the macro BS 1a, based on the ABS information acquired from the macro BS 1a. The setting unit 24, if necessary, sets a position of a blank section such as an ABS so as to also protect the macro control signals as shown in FIG. 11.

When it has been determined that no pico BS 1b is present in the neighborhood of the femto BS 1c, the setting unit 24 sets a position of a blank section such as an ABS so as to protect the macro control signals without considering protection of a pico control signals as shown in FIG. 7 (step S54). That is, the femto BS 1c performs setting of the blank position without considering the ABS information acquired from the macro BS 1a.

When the pico BS 1b performs the cell range expansion as shown in FIG. 24, the pico BS 1b previously acquires, from the macro BS 1a via the inter-base-station network, the ABS information indicating the frame position of the ABS in the macro BS 1a (macro ABS). Then, the pico BS 1b and the pico terminal 2b perform the cell range expansion during the section of the macro ABS, thereby realizing the cell range expansion while avoiding interference from the macro BS 1a.

[3.6 Determination Based on Information from Inter-Base-Station Network]

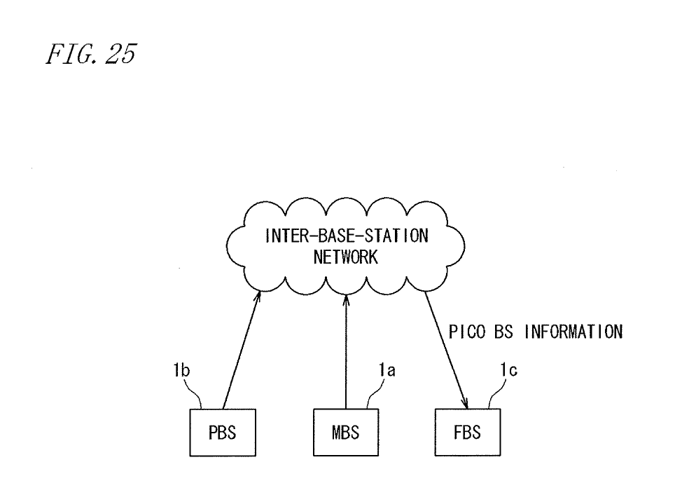

In the determination methods of above [3.1] to [3.5], determination as to whether a pico BS 1b (another base station device) is present in the neighborhood of the femto BS 1c has been performed based on the wirelessly acquired information. However, the determination may be performed based on information from the inter-base-station network. The information acquired from the inter-base-station network by the information acquisition unit 26 of the femto BS 1c may be similar to those acquired by the determination methods of above [3.1] to [3.5], or may be information directly indicating whether a pico BS 1b is present in the neighborhood of the femto BS 1c (pico BS information) as shown in FIG. 25. When performing the determination based on the information from the inter-base-station network, the transmission source of the information is not necessarily a base station device, but may be a server (management device) that manages information of the base station device.

[3.7 Determination Based on Information from Server]

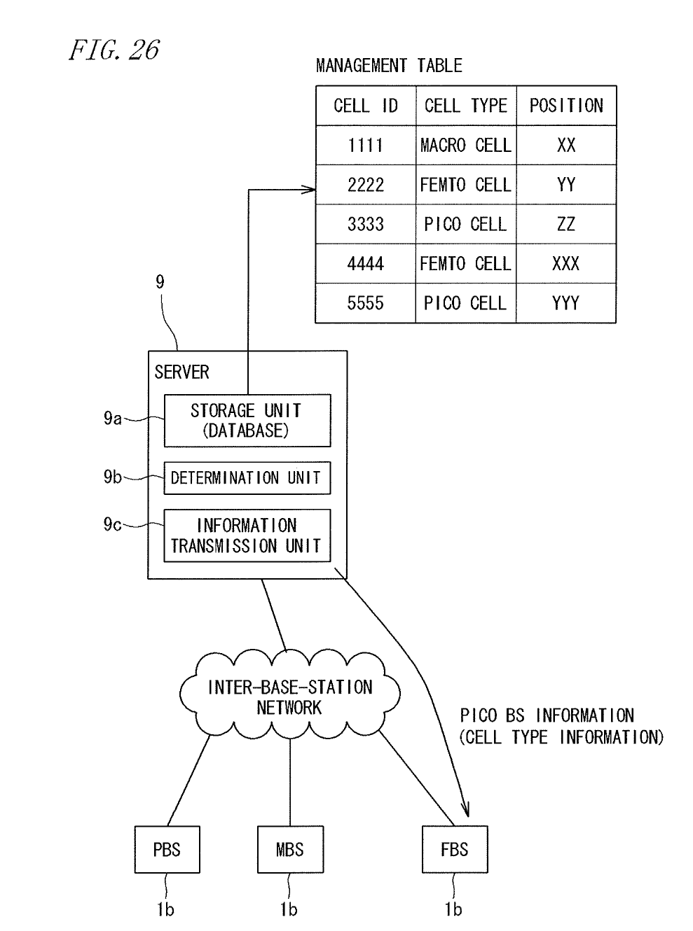

FIG. 26 shows a method of determining whether a pico BS 1b is present in the neighborhood of the femto BS 1c, based on information transmitted from a server (management device) 9 provided in the inter-base-station network or in a network connected to the inter-base-station network.

As shown in FIG. 26, the server 9 includes a storage unit (database) 9a, a determination unit 9b, and an information transmission unit 9c. The storage unit 9a of the server 9 has a management table for managing a plurality of base station devices. The management table has, stored therein, the cell IDs of the respective base station devices (base station device IDs), the cell types of the base station devices (base station device types), the locations of the base station devices, and the like.

These pieces of information registered in the management table were input to the server 9 when the base station devices were installed, for example. The pieces of information registered in the management table may be those collected from the installed base station devices via a network such as the inter-base-station network.

The base station device (particularly, the femto BS 1c) 1 transmits, to the server 9, an inquiry about whether a pico BS 1b is present in the neighborhood of the base station device 1, or an inquiry about the cell types of other base station devices which are present in the neighborhood of the base station device 1. The inquiry includes the cell ID of the base station device 1 that has made the inquiry, and if necessary, location information of the base station device 1.

Upon receiving, from the base station device 1, the inquiry about presence/absence of a neighboring pico BS 1b (another base station device), the server 9 specifies the location of the base station device 1 specifies, based on the cell ID of the base station device 1 that has made the inquiry, the location of the base station device 1 with reference to the location information in the management table (this process of specifying the location is not necessary if the inquiry includes the location information). Further, the server 9 compares the specified location of the base station device 1 with the locations of other base station devices in the management table, and extracts other base station devices that are present in the neighborhood of the base station device 1 that has made the inquiry.

The determination unit 9b of the server 9 refers to the cell type information in the management table. If a base station device whose cell type is “pico cell (pico BS)” is included in the extracted base station devices, the determination unit 9b determines that a pico BS is present in the neighborhood of the base station device 1 that has made the inquiry.

Then, the information transmission unit 9c of the server 9 transmits, as a response to the inquiry from the base station device 1, information (pico BS information) indicating that a pico BS is present in the neighborhood of the base station device 1.

If a base station device whose cell type is “pico cell (pico BS)” is not included in the extracted base station devices, the determination unit 9b of the server 9 determines that no pico BS is present in the neighborhood of the base station device 1 that has made the inquiry. Then, the information transmission unit 9c transmits, as a response to the inquiry from the base station device 1, information (pico BS information) indicating that no pico BS is present in the neighborhood of the base station device 1. In the present embodiment, the pico BS information is information indicating whether a neighboring pico BS 1b is present.

On the other hand, when receiving the inquiry about the cell types of the other neighboring base station devices, the server 9 specifies, based on the cell ID of the base station device 1 that has made the inquiry, the location of the base station device 1 with reference to the location information in the management table (this process of specifying the location is not necessary if the location information is included in the inquiry). Further, the server 9 compares the specified location of the base station device 1 with the positions of the other base station devices in the management table, and extracts other base station devices that are present in the neighborhood of the base station device 1 that has made the inquiry.

Then, the information transmission unit 9c of the server 9 refers to the management table, and acquires the cell types of the extracted one or a plurality of base station devices, and transmits information indicating the cell types of the respective base station devices (cell type information) as a response to the inquiry of the base station device 1.

The determination unit 25 of the base station device (femto BS 1c) 1, which has received the pico BS information or the cell type information as a response, can determine whether a pico BS is present in the neighborhood of the base station device 1, based on the received pico BS information or cell type information.

The server (management device) 9 is not necessarily provided as an independent device, but for example a base station device may have the function of the server (management device) 9.

Further, the server 9 may autonomously transmit the pico BS information or the pico type information to the base station device 1 even if the server 9 does not receive an inquiry from the base station device 1. The server 9 may transmit the information (cell types and the like) registered in the management table to a base station device (macro BS or pico BS) of a type different from the femto BS 1c.

### 4. Type of BS and Priority of Access

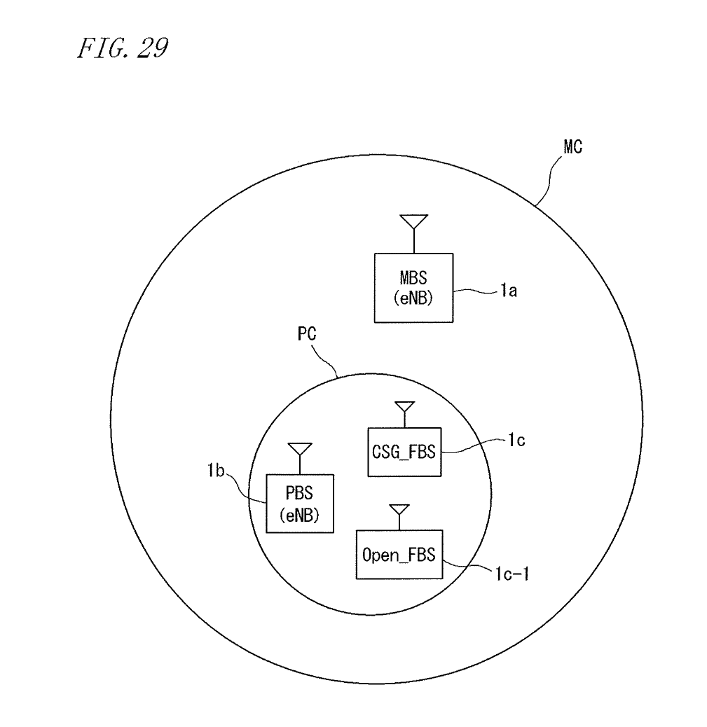

FIG. 29 shows a state in which a pico BS 1b is present in a macro cell formed by a macro BS 1a, and a CGS femto BS 1c and an Open femto BS 1c-1 are present in a pico cell PC formed by the pico BS 1b.

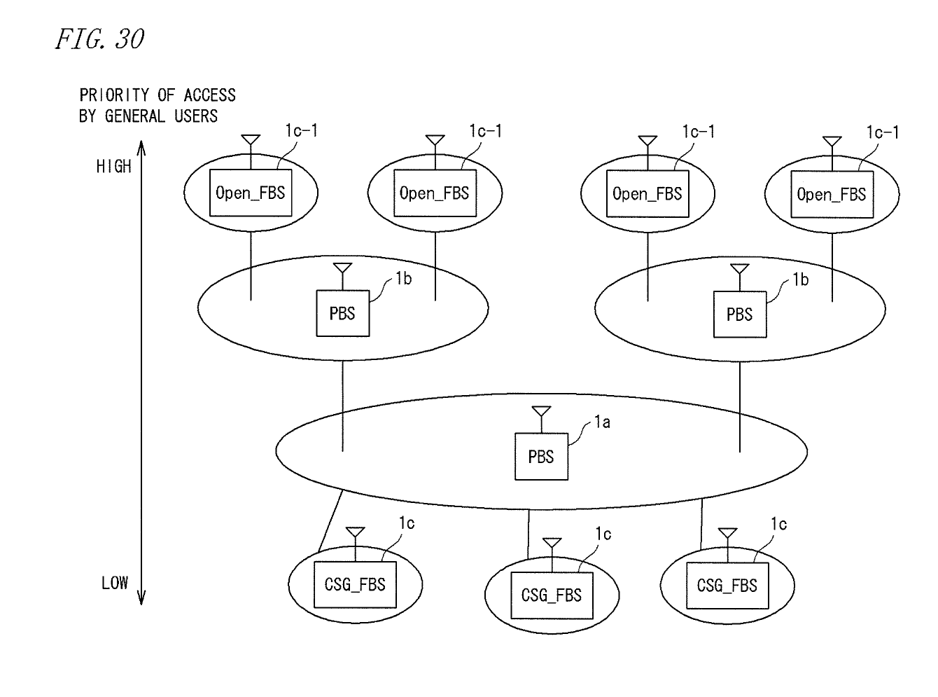

FIG. 30 shows the priority of access by a general user (terminal device 2) with respect to the four types of base station devices. Among the four types of base station devices 1a, 1b, 1c, and 1c-1, the Open femto BS 1c-1 is given the highest priority of access, and the pico BS 1b, the macro BS 1a, and the CSG femto 1c follow in this order.

When there are a plurality of base station devices to which the terminal device 2 is accessible, the terminal device 2 preferentially accesses a base station device that is higher in the priority of access.

Usually, when there are a plurality of base station devices to which the terminal device 2 is accessible, the terminal device 2 accesses a base station device whose signal reception power in the terminal device 2 is highest. For example, when the terminal device 2 is accessible to a plurality of macro BSs 1a, the terminal device 2 accesses (performs handover to) a base station device whose signal reception power in the terminal device 2 is highest.

On the other hand, for example, in a case where the terminal device 2 is accessible to a macro BS 1a and a pico BS 1b, even if the reception power of a signal transmitted from the pico BS 1b is somewhat lower than the reception power of a signal transmitted from the macro BS 1a, the terminal device 2 accesses the pico BS 1b that is higher in priority than the macro BS 1a. That is, with respect to the power of the signal transmitted from the pico BS 1b that is higher in priority, the terminal device 2 adds a predetermined value to the magnitude of the actual reception power so that the reception power is regarded as being higher than the actual reception power. Thereby, the terminal device 2 preferentially accesses the pico BS 1b that is higher in priority. This is to reduce the load on the macro BS 1a by causing as many terminal devices 2 as possible to access the pico BS 1b that forms the pico cell PC smaller than the macro cell MC.

Likewise, in a case where the terminal device 2 is accessible to a pico BS 1b and an Open femto BS 1c-1, even if the reception power of a signal transmitted from the Open femto BS 1c-1 is somewhat smaller than the reception power of a signal transmitted from the pico BS 1b, the terminal device 2 accesses the Open femto BS 1c-1 that is higher in priority than the pico BS 1b. This is to reduce the load on the pico BS 1b by causing as many terminal devices 2 as possible to access the Open femto BS 1c-1 that forms the femto cell FC smaller than the pico cell PC.

Furthermore, a general terminal device 2 which is not allowed to access the CSG femto BS 1c cannot access the CSG femto BS 1c even if it is located in the femto cell FC formed by the CSG femto BS 1c. That is, even if the reception power of a signal transmitted from the CSG femto BS 1c is higher than the reception power of a signal transmitted from the macro BS 1a, or the pico BS 1b, or the Open femto BS 1c-1, the terminal device 2 accesses the macro BS 1a, or the pico BS 1b, or the Open femto BS 1c-1, which are higher in priority than the CSG femto BS 1c.

When the priorities (types) of a plurality of base station devices to which the terminal device 2 is accessible are the same, the terminal device 2 accesses a base station device whose signal reception power in the terminal device 2 is highest, as per normal.

### 5. First Modification

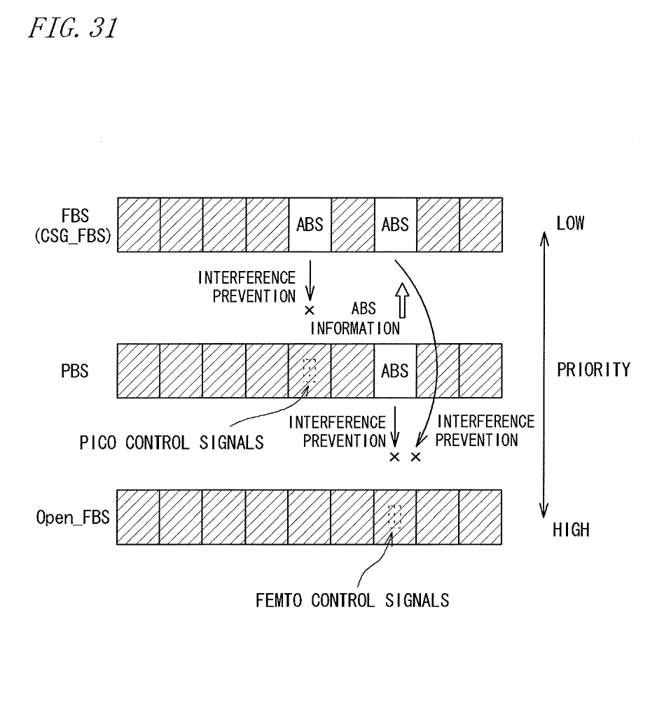

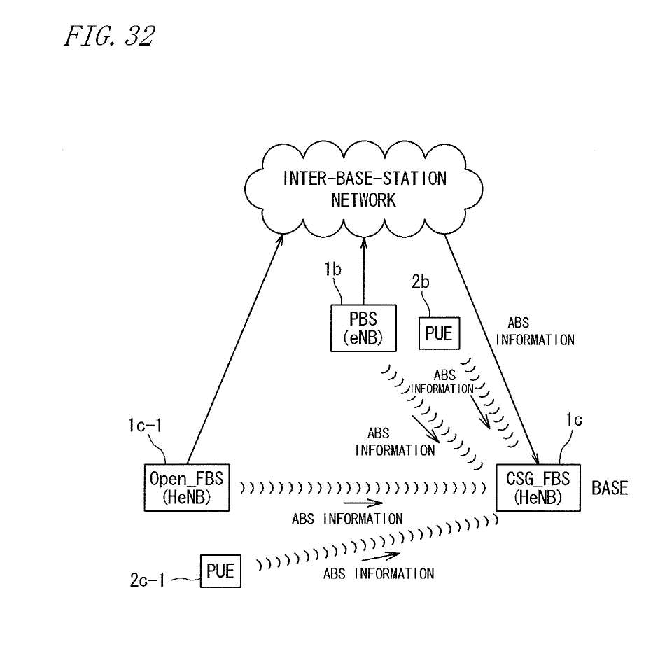

FIGS. 31 and 32 show a first modification relating to FIGS. 11 and 10. In the first modification, both the CSG femto BS 1c and the Open femto BS 1c-1 are present in the pico cell PC, and the Open femto BS 1c-1 is so close to the CSG femto BS 1c that interference from the CSG femto BS 1c causes a problem.

In FIGS. 10 and 11, the acquisition unit 26 of the CSG femto BS 1c acquires the ABS information indicating the position of the ABS in the macro BS 1a. However, in the first modification shown in FIGS. 31 and 32, the acquisition unit 26 of the CSG femto BS 1c acquires the ABS information indicating the position of the ABS in the pico BS 1b that is higher in priority of access by the terminal device 2 than the femto BS 1c.

In FIG. 31, the pico BS 1b, the CSG femto BS 1c, and the Open femto BS 1c-1 are taken into consideration without considering the presence of the macro BS 1a shown in FIG. 29.

Based on the ABS information indicating the position of the ABS in the pico BS 1b, the blank section setting unit 24 of the CSG femto BS 1c sets an ABS in the position corresponding to the position of the ABS in the pico BS 1b, as shown in FIG. 31. The position of the ABS in the pico BS 1b is set for preventing interference to the femto cell (for protecting the femto control signals) formed by the Open femto BS 1c-1 that is higher in priority.

The CSG femto BS 1c sets the position of the ABS in itself in accordance with the position of the ABS set by the pico BS 1b that is higher in priority of access by the terminal device 2 than the CSG femto BS 1c, thereby realizing prevention of interference to the femto cell (protection of the femto control signals) formed by the Open femto BS 1c-1 that is higher in priority.

While in FIG. 31 the CSG femto BS 1c also sets an ABS for preventing interference to the pico cell formed by the pico BS 1b (for protecting the pico control signals), the CSG femto BS 1c need not necessarily set such an ABS.

FIG. 32 shows variations of routes through which the CSG femto BS 1c acquires the information (ABS information) indicating the position of the ABS in the transmission frame from the pico BS 1b. The variations of the routes shown in FIG. 32 are identical to those shown in FIG. 10. That is, the information acquisition unit 26 of the CSG femto BS 1c can acquire the ABS information of the pico BS 1b wirelessly or via a cable from the pico BS 1b. Alternatively, the information acquisition unit 26 of the CSG femto BS 1c can acquire the ABS information of the pico BS 1b via the pico terminal 2b, the Open femto BS 1c-1, the Open femto terminal 2c-1, or the like.

Also in the first modification, the CSG femto BS 1c performs determination as to whether an Open femto BS 1c-1 is present in the neighborhood of the femto BS 1c, and when the result of the determination is that a neighboring Open femto BS 1c-1 is present, the CSG femto BS 1c can set an ABS as shown in FIG. 31 based on the acquired ABS information.

When the result of the determination is that no Open femto BS 1c-1 is present in the neighborhood of the CSG femto BS 1c, the CSG femto BS 1c sets a position of an ABS so as to protect the pico control signals, without considering protection of the femto control signals of the Open femto BS 1c-1. That is, the CSG femto BS 1c performs setting of the blank position without considering the ABS information of the pico BS 1b.

The determination as to whether a neighboring Open femto BS 1c-1 is present may be performed based on any of the methods described in the above [3.1] to [3.4], [3.6], and [3.7].

### 6. Second Modification

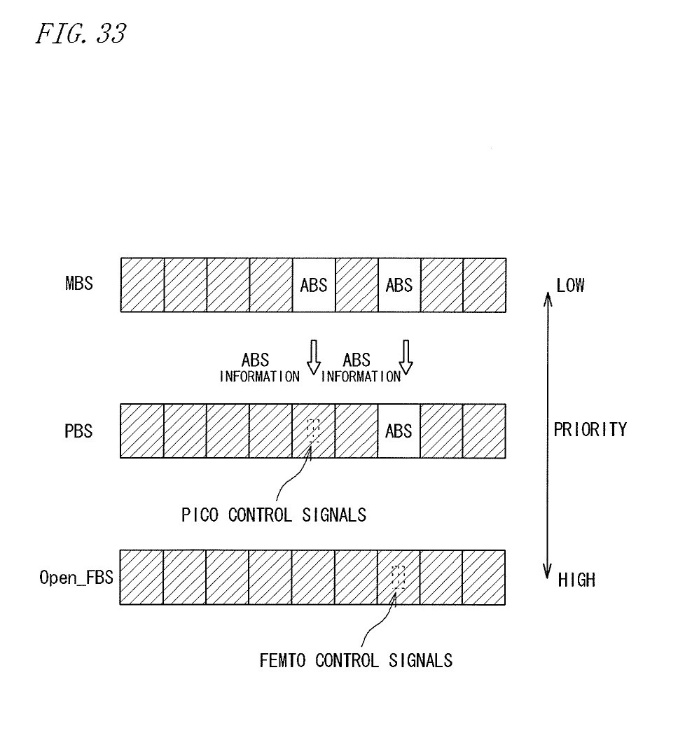

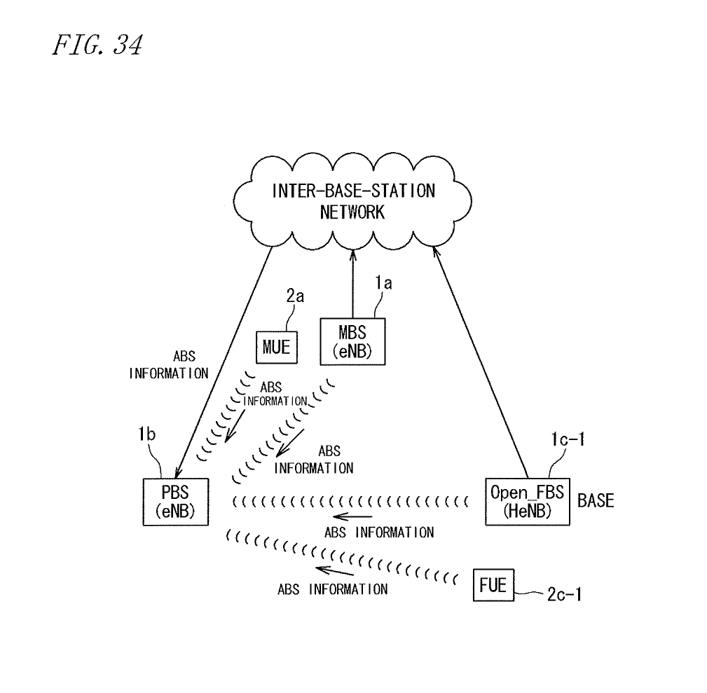

FIGS. 33 and 34 show a second modification relating to FIGS. 11 and 10. Also in the second modification, the arrangement of the base station devices shown in FIG. 29 is assumed. In the second modification, however, the macro BS 1a, the pico BS 1b, and the Open femto BS 1c-1 are taken into consideration without considering the presence of the CSG femto 1c.

In the second modification, setting of ABS in the pico BS 1b will be described. The pico BS 1b has the same configuration as that shown in FIG. 5.

The acquisition unit 26 of the pico BS 1b acquires the ABS information of the macro BS 1a that is lower in priority of access by a terminal device than the pico BS 1b.

Based on the ABS information indicating the position of the ABS in the macro BS 1a, the blank section setting unit 24 of the pico BS 1b sets an ABS in the position corresponding to the position of the ABS in the macro BS 1a as shown in FIG. 33. The position of the ABS in the macro BS 1a is set for preventing interference to the femto cell (for protecting the femto control signals) formed by the Open femto BS 1c-1 which is higher in priority than the pico BS 1b (and the macro BS 1a).

The pico BS 1b sets the position of the ABS in itself in accordance with the position of the ABS set by the macro BS 1a for the Open femto BS 1c-1 which is higher in priority than the pico BS 1b, thereby preventing interference to the femto cell (protecting the femto control signals) formed by the Open femto BS 1c-1 which is higher in priority than the pico BS 1b.

Although in FIG. 33 the macro BS 1a also sets an ABS for preventing interference to the pico cell (for protecting the pico control signals) formed by the pico BS 1b, the pico BS 1b need not set such ABS in itself, in the position of the ABS for preventing interference to the pico cell PC.

As described above, if it is not preferable or necessary for the pico BS 1b to set an ABS in the same position as the ABS set by the another base station device 1a, the pico BS 1b need not set an ABS in the same position as the ABS set by the another base station device 1a.

FIG. 34 shows the variations of routes through which the pico BS 1b acquires the information (ABS information) indicating the position of the ABS in the transmission frame of the macro BS 1b. The information acquisition unit 26 of the pico BS 1b can acquire the ABS information of the macro BS 1a from the macro BS 1a wirelessly or via a cable. Alternatively, the information acquisition unit 26 of the pico BS 1b can acquire the ABS information of the macro BS 1a via the macro terminal 2a, the Open femto BS 1c-1, the Open femto terminal 2c-1, or the like.

Also in this second modification, the pico BS 1b performs determination as to whether an Open femto BS 1c-1 is present in the neighborhood of the pico BS 1b, and when the result of the determination is that a neighboring Open femto BS 1c-1 is present, the pico BS 1b can set an ABS as shown in FIG. 33 based on the acquired ABS information.

When the result of the determination is that no Open femto BS 1c-1 is present in the neighborhood of the pico BS 1b, the pico BS 1b need not consider protection of the femto control signals of the Open femto BS 1c-1. That is, the pico BS 1b need not consider the ABS information of the macro BS 1a when setting the blank position.

The determination as to whether a neighboring Open femto BS 1c-1 is present may be performed based on any of the methods described in the above [3.1] to [3.4], [3.6], and [3.7].

### 7. Third Embodiment

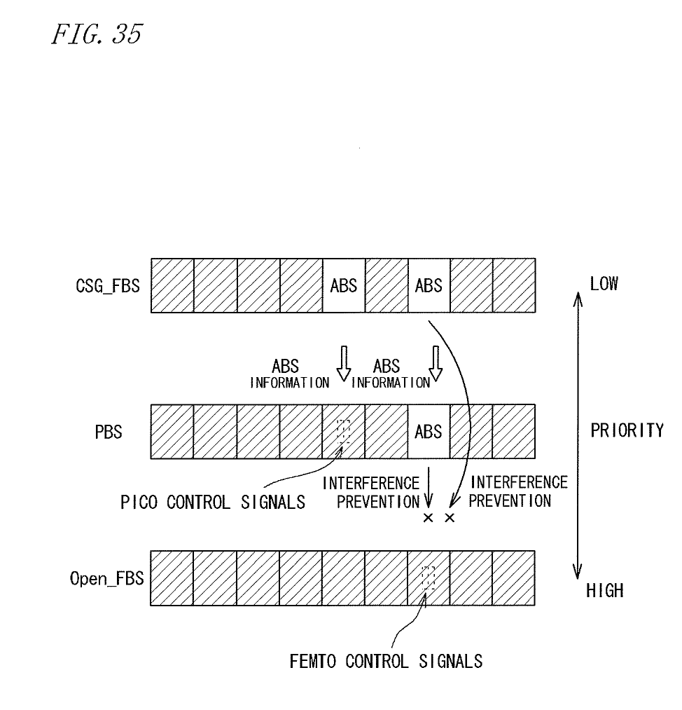

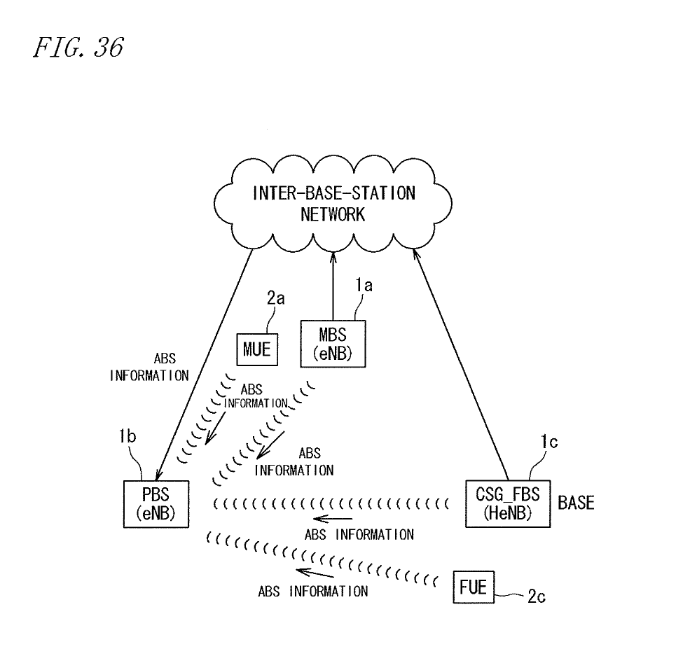

FIGS. 35 and 36 show a third modification relating to FIGS. 11 and 10. Also in this third modification, the arrangement of the base station devices shown in FIG. 29 is assumed. In the third modification, however, the pico BS 1b, the CSG femto BS 1c, and the Open femto BS 1c-1 are taken into consideration without considering the presence of the macro BS 1a.

Also in this third modification, setting of ABS in the pico BS 1b will be described as in the second modification.

The acquisition unit 26 of the pico BS 1b acquires the ABS information of the CSG femto BS 1c that is lower in priority of access by a terminal device than the pico BS 1b.

Based on the ABS information indicating the position of the ABS in the CSG femto BS 1c, the blank section setting unit 24 of the pico BS 1b sets an ABS in the position corresponding to the position of the ABS in the CSG femto BS 1c as shown in FIG. 35. The position of the ABS in the CSG femto BS 1c is set for preventing interference to the femto cell (for protecting the femto control signals) formed by the Open femto BS 1c-1 that is higher in priority than the pico BS 1b (and the CSG femto BS 1c).

The pico BS 1b sets the position of the ABS in itself in accordance with the position of the ABS set by the Open femto BS 1c-1 that is higher in priority than the pico BS 1b, thereby realizing prevention of interference to the femto cell (protection of the femto control signals) formed by the Open femto BS 1c-1 that is higher in priority than the pico BS 1b.

Although in FIG. 35 the CSG femto BS 1c also sets an ABS for preventing interference to the pico cell formed by the pico BS 1b (for protecting the pico control signals), the pico BS 1b need not set such ABS in itself, in the position of the ABS for preventing interference to the pico cell PC, as in the second modification.

FIG. 36 shows variations of routes through which the pico BS 1b acquires the information (ABS information) indicating the position of the ABS in the transmission frame of the CSG femto BS 1c. The information acquisition unit 26 of the pico BS 1b can acquire the ABS information of the CSG femto BS 1c from the CSG femto BS 1c wirelessly or via a cable. Alternatively, the information acquisition unit 26 of the pico BS 1b may acquire the ABS information of the CSG femto BS 1a via the CSG femto terminal 2c, the macro BS 1a, the macro terminal 2a, or the like.

Also in this third modification, the pico BS 1b performs determination as to whether an Open femto BS 1c-1 is present in the neighborhood of the pico BS 1b, and when the result of the determination is that a neighboring Open femto BS 1c-1 is present, the pico BS 1b may set an ABS as shown in FIG. 35 based on the acquired ABS information.

When the result of the determination is that no Open femto BS 1c-1 is present in the neighborhood of the pico BS 1b, the pico BS 1b need not consider protection of the femto control signals of the Open femto BS 1c-1. That is, the pico BS 1b need not consider the ABS information of the macro BS 1a when setting the blank position.

The determination as to whether a neighboring Open femto BS 1c-1 is present may be performed based on any of the methods described in the above [3.1] to [3.4], [3.6], and [3.7].

### 8. Fourth Modification

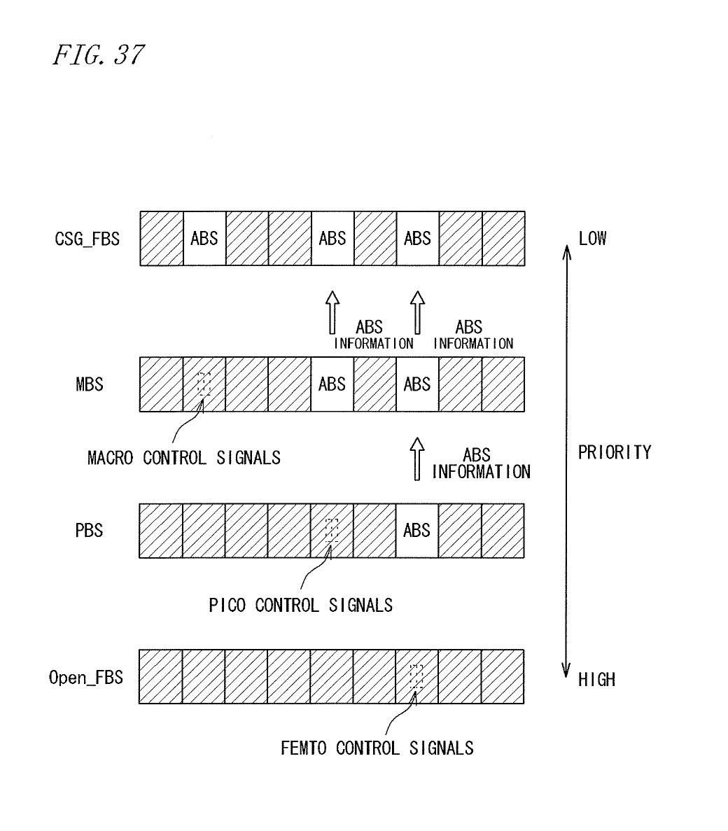

FIG. 37 shows a fourth modification. Also in the fourth modification, the arrangement of the base station devices shown in FIG. 29 is assumed.

In the fourth modification, setting of ABS in the macro BS 1a and setting of ABS in the CSG femto BS 1c will be described. The macro BS 1b has the same configuration as that shown in FIG. 5.

In the fourth modification, the macro BS 1a performs a process similar to the process of the CSG femto BS 1c of the first modification (FIG. 31).

That is, the acquisition unit 26 of the macro BS 1a acquires the ABS information of the pico BS 1b that is higher in priority of access by a terminal device than the macro BS 1a.

Based on the ABS information indicating the position of the ABS in the pico BS 1b, the blank section setting unit 24 of the macro BS 1a sets an ABS in the position corresponding to the position of the ABS in the pico BS 1b as shown in FIG. 37. The position of the ABS in the pico BS 1b is set for preventing interference to the femto cell (for protecting the femto control signals) formed by the Open femto BS 1c-1 that is higher in priority.

Further, the macro BS 1a sets, in addition to the ABS based on the position of the ABS in the pico BS 1b, an ABS for preventing interference to the pico cell formed by the pico BS 1b (for protecting the pico control signals).

The CSG femto BS 1c of the fourth modification performs a process similar to the process of the CSG femto BS 1c shown in FIG. 11.

That is, the acquisition unit 26 of the CSG femto BS 1c acquires the ABS information of the macro BS 1a that is higher in priority of access by a terminal device than the femto BS 1c.

Based on the ABS information indicating the position of the ABS in the macro BS 1a, the blank section setting unit 24 of the CSG femto BS 1c sets ABSs in the positions corresponding to the two ABSs in the macro BS 1a as shown in FIG. 37. The positions of the ABSs in the macro BS 1a are set for preventing interferences to the pico cell formed by the pico BS 1b and the femto cell formed by the Open femto BS 1c-1 (for protecting the femto control signals), which are higher in priority.

Further, the CSG femto BS 1c sets, in addition to the ABSs based on the positions of the ABSs in the macro BS 1a, an ABS for preventing interference to the pico cell formed by the macro BS 1a (for protecting the pico control signals).

By setting the positions of the ABSs as shown in FIG. 37, it is possible to reduce interferences to the cells formed by the base station devices that are higher in priority of access by the terminal device 2.

### 9. Fifth Embodiment

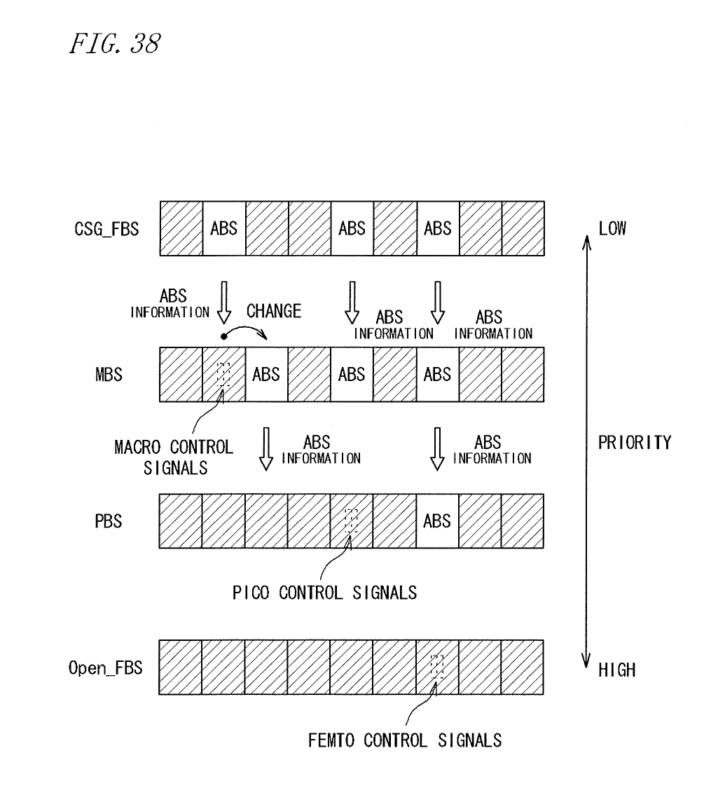

FIG. 38 shows a fifth modification. Also in this fifth modification, the arrangement of the base station devices shown in FIG. 29 is assumed.

In the fifth modification, setting of ABS in the macro BS 1a and setting of ABS in the pico BS 1b will be described.

The acquisition unit 26 of the macro BS 1a acquires the ABS information of the CSG femto 1c that is lower in priority of access by a terminal device than the macro BS 1a.

Based on the ABS information indicating the positions of ABSs in the CSG femto BS 1c, the blank section setting unit 24 of the macro BS 1a sets ABSs in the positions corresponding to the positions of the ABSs in the CSG femto BS 1c as shown in FIG. 38. The positions of the ABSs in the CSG femto BS 1c are set for preventing interferences to the femto cells formed by the macro BS 1a, the pico BS 1b, and the Open femto BS 1c-1, which are higher in priority than the CSG femto BS 1c.

The macro BS 1a sets the positions of the ABSs in itself in accordance with the positions of the ABSs that are set by the CSG femto BS 1c for the pico BS 1b and the Open femto BS 1c-1 which are higher in priority than the macro BS 1a, thereby realizing prevention of interferences to the pico cell formed by the pico BS 1b and the femto cell formed by the Open femto BS 1c-1 (protection of the femto control signals), which are higher in priority than the macro BS 1a.

Further, although in FIG. 38 the CSG femto BS 1c also sets an ABS for preventing interference to the macro cell formed by the macro BS 1a (for protecting the macro control signals), the macro BS 1a need not set an ABS in itself, in the position of the ABS for preventing interference to the macro cell MC.

So, the blank section setting unit 24 of the macro BS 1a sets an ABS in a subframe different from the subframe in which the macro control signals are contained. That is, the blank section setting unit 24 sets an ABS in a position different from the position of the ABS in the CSG femto BS 1c (in FIG. 38, a subframe to the immediate right of the macro control signals). In this way, instead of setting an ABS in accordance with the position of the ABS shown in the acquired ABS information, the macro BS 1a firstly determines whether it is necessary to set an ABS in the position of the ABS shown in the acquired ABS information, and then sets a position of an ABS in itself, thereby realizing more appropriate setting of ABS.

The ABS thus set (the subframe to the immediately right of the macro control signals shown in FIG. 38) can be actively used for communication such as transmission of a data signal by the pico BS 1b that is higher in priority.

The pico BS 1b of the fifth modification performs a process similar to the process of the pico BS 1b according to the second modification (FIG. 33).

That is, the acquisition unit 26 of the pico BS 1b acquires the ABS information of the macro BS 1a that is lower in priority of access by a terminal device than the pico BS 1b.

Based on the ABS information indicating the positions of ABSs in the macro BS 1a, the blank section setting unit 24 of the pico BS 1b sets an ABS in the position corresponding to the position of an ABS in the macro BS 1a as shown in FIG. 38. The positions of the ABSs in the macro BS 1a are set for preventing interferences to the pico cell formed by the pico BS 1b and the femto cell formed by the Open femto BS 1c-1, which are higher in priority than the macro BS 1a.

The pico BS 1b sets the position of the ABS in itself in accordance with the position of the ABS that is set by the macro BS 1a for the Open femto BS 1c-1 that is higher in priority than the pico BS 1b, thereby realizing prevention of interference to the femto cell (protection of the femto control signals) formed by the Open femto BS 1c-1 that is higher in priority than the pico BS 1b.

Although in FIG. 38 the macro BS 1a also sets an ABS for preventing interference to the pico cell formed by the pico BS 1b (for protecting the pico control signals), the pico BS 1b need not set an ABS in itself, in the position of the ABS for preventing interference to the pico cell PC.

By setting the ABSs as shown in FIG. 38, it is possible to reduce interferences to the cells formed by the base station devices that are higher in priority of access by the terminal device 2.

### 10. Sixth Modification

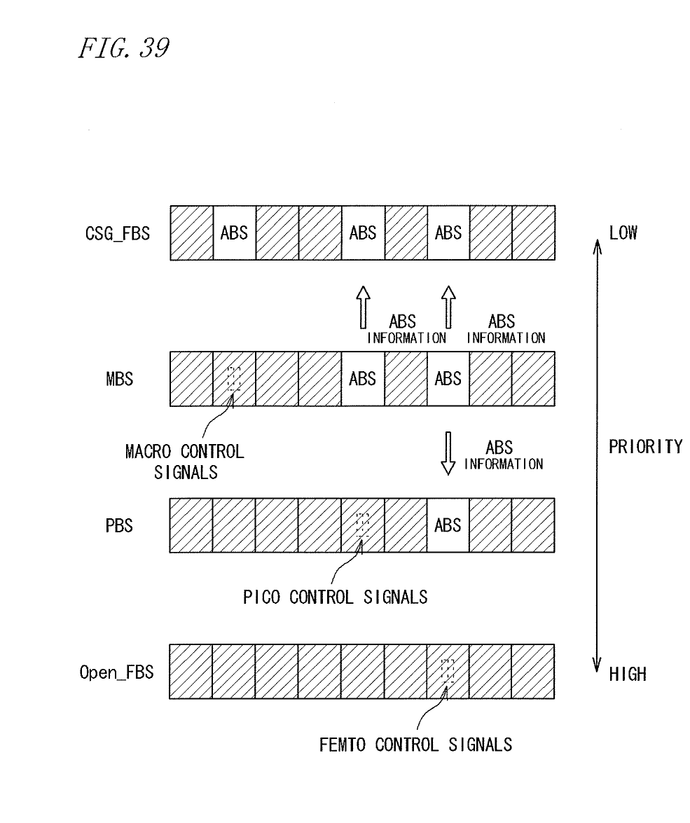

FIG. 39 shows a sixth modification. Also in the sixth modification, the arrangement of the base station devices shown in FIG. 29 is assumed.

In the sixth modification, setting of ABS in the pico BS 1b and setting of ABS in the CSG femto BS 1c will be described.

In the sixth modification, the pico BS 1b performs a process similar to the process of the pico BS 1b of the fifth modification. That is, the acquisition unit 26 of the pico BS 1b acquires the ABS information of the macro BS 1a that is lower in priority of access by a terminal device than the pico BS 1b, and performs setting of ABS positions.

In the sixth modification, the CSG femto BS 1c performs a process similar to the process of the CSG femto 1c of the fourth modification. That is, the acquisition unit 26 of the CSG femto BS 1c acquires the ABS information of the macro BS 1a that is higher in priority of access by the terminal device than the femto BS 1c, and performs setting of ABS positions.

By setting the positions of ABSs as shown in FIG. 39, it is possible to reduce interferences to the cells formed by the base station devices that are higher in priority of access by the terminal device 2.

### 11. Seventh Modification

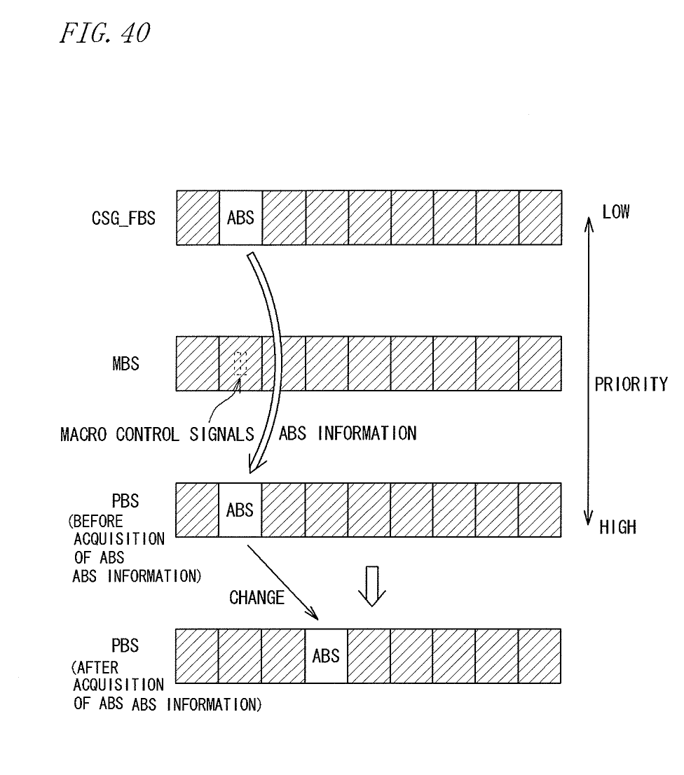

FIG. 40 shows a seventh modification. In the seventh modification, a base station device sets, based on ABS information of another base station device, an ABS in a position different from the position of an ABS in the another base station device.

The pico BS 1b of the seventh modification acquires ABS information from the CSG femto BS 1c. It is assumed that, before the acquisition of the ABS information, the pico BS 1b sets an ABS in the same position as the position of the ABS in the CSG femto BS 1c. The ABS in the CSG femto BS 1c is set for preventing interference to the macro cell (for protecting the macro control signals) formed by the macro BS 1a that is lower in priority than the pico BS 1b.

The pico BS 1b acquires the ABS information of the CSG femto BS 1c. The pico BS 1b detects, based on the acquired ABS information, that the position of the ABS in the pico BS 1b coincides with the position of the ABS that is set by the CSG femto BS 1c for the macro BS 1a that is lower in priority than the pico BS 1b. Then, the pico BS 1b changes the position of the ABS in the pico BS 1b to another position as shown in FIG. 40.

The pico BS 1b can know that the ABS in the CSG femto BS 1c is set for protecting the control signals of the macro BS 1a, by acquiring the information indicating the position of the macro control signals from the macro BS 1a.

By adjusting the timing of the femto control signals of the Open femto BS 1c-1 so that the femto control signals are transmitted at the position of the ABS having been changed, it is possible to prevent interference from the pico BS 1b to the Open femto cell.

### 12. Eighth Modification

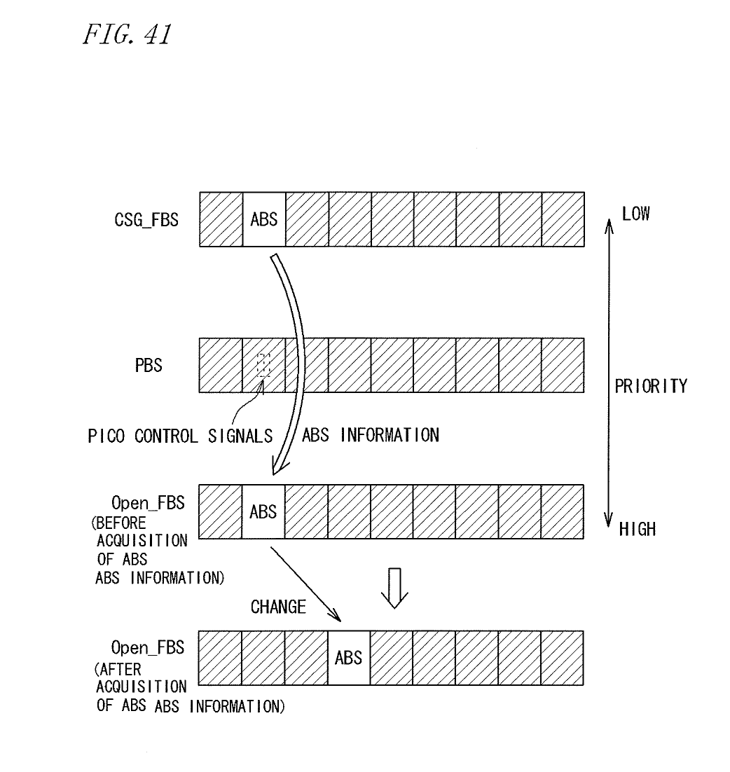

FIG. 41 shows an eighth modification. Also in this eighth modification, as in the seventh modification, a base station device sets, based on ABS information of another base station device, an ABS in a position different from the position of an ABS in the another base station device.

The Open femto BS 1c-1 of the eighth modification acquires ABS information from the CSG femto BS 1c. It is assumed that, before the acquisition of the ABS information, the Open femto BS 1c-1 sets an ABS in the same position as the position of an ABS in the CSG femto BS 1c. The ABS in the CSG femto BS 1c is set for preventing interference to the macro cell (for protecting the macro control signals) formed by the pico BS 1b that is lower in priority than the Open femto BS 1c-1.

The Open femto BS 1c-1 acquires the ABS information of the CSG femto BS 1c. The Open femto BS 1c-1 detects, based on the acquired ABS information, that the position of the ABS in the femto BS 1c-1 coincides with the position of the ABS that is set by the CSG femto BS 1c for the pico BS 1b that is lower in priority than the femto BS 1c-1. Then, the Open femto BS 1c-1 changes the position of the ABS in the Open femto BS 1c-1 to another position as shown in FIG. 41.

### 13. Consideration

In the above description, a base station device has acquired ABS information (information indicating the position of a blank radio resource) from a target base station device to be referred to for the position of an ABS (blank radio resource), among a plurality of other base station devices (refer to FIGS. 9, 11, 31, 33, 35, and 37 to 41).

For the base station device which sets a position of an ABS based on the acquired ABS information, the target base station device (another base station device) to be referred to for the position of the ABS (blank radio resource) can be another base station device which is higher in priority of access by a terminal device 2 than the base station device (another base station device of higher priority). The target base station device (another base station device) corresponds to, for example, any of the macro BS 1a shown in FIGS. 9 and 11, the pico BS 1b shown in FIG. 31, and the macro BS 1a and the pico BS 1b shown in FIG. 37.

The ABS (blank radio resource) in the target base station device (another base station device) can be an ABS that is set for preventing interference to a cell of a preferential base station device that is higher in priority of access by a terminal device than the target base station device (another base station device). The preferential base station device (still another base station device different from the above-mentioned another base station device) corresponds to, for example, any of the pico BS 1b shown in FIGS. 9 and 11, the Open femto BS 1c-1 shown in FIG. 31, and the pico BS 1b and the Open femto BS 1c-1 shown in FIG. 37.

For the base station device which sets a position of an ABS based on the acquired ABS information, the preferential base station device (still another base station device different from the above-mentioned another base station device) is desirably a neighboring base station device which is located so close to the base station device that interference avoidance is necessary.

Further, for the base station device that sets a position of an ABS based on the acquired ABS information, the target base station device (another base station device) to be referred to for the position of the ABS (blank radio resource) may be another base station device (lower-priority base station device) which is lower in priority of access by the terminal device than the base station device. The target base station device (another base station device) corresponds to, for example, any of the macro BS 1a shown in FIG. 33, the CSG femto BS 1c shown in FIG. 35, the CSG femto 1c and the macro BS 1a shown in FIG. 38, and the CSG femto BS 1c shown in FIGS. 40 and 41.

For the base station device which sets a position of an ABS based on the acquired ABS information, the ABS (blank radio resource) set in the target base station device (another base station device) can be an ABS set for preventing interference to a cell of a preferential base station device which is higher in priority of access by the terminal device than the base station device. The preferential base station device (still another base station device different from the above-mentioned another base station device) corresponds to, for example, any of the Open femto BS 1c-1 shown in FIGS. 33 and 35, and the pico BS 1b and the Open femto BS 1c-1 shown in FIG. 38.

For the base station device that sets a position of an ABS based on the acquired ABS information, the preferential base station device (still another base station device different from the above-mentioned another base station device) is desirably a neighboring base station device which is located so close to the base station device that interference avoidance is necessary.

### 14. Appended Note 1

[14.1] A base station device which can be privately used by customers of a telecommunications carrier, such as individuals or companies, comprising: a setting unit that sets, in a transmission frame, a blank section during which no data signal is transmitted; and a determination unit that determines whether a small-size public base station device that forms a cell smaller than a macro cell is present in the neighborhood of the base station device, wherein the setting unit adjusts the position where the blank section is set, in accordance with a result of the determination as to whether a small-size public base station device is present in the neighborhood of the base station device.

The base station device determines whether a small-size public base station device is present in the neighborhood of the base station device, and adjusts the position of the blank section. Therefore, if a small-size public base station device is present in the neighborhood of the base station device, the base station device can set the blank section in accordance with the small-size public base station device.

[14.2] The base station device according to [14.1], wherein when the determination unit has determined that a small-size public base station device is present in the neighborhood of the base station device, the setting unit sets the blank section in a frame position corresponding to a transmission section for transmitting a control signal contained in a transmission frame of the small-size public base station device. In this case, even if a small-size public base station device is present in the neighborhood of the base station device, it is possible to prevent a radio wave radiated from the base station device from adversely affecting the control signal contained in the transmission frame of the small-size public base station device.

[14.3] The base station device according to [14.1] or [14.2], wherein when the determination unit has determined that a small-size public base station device is present in the neighborhood of the base station device, the setting unit sets the blank section in a frame position corresponding to a blank section in a transmission frame of a macro base station device that forms a macro cell.

Since the blank section in the transmission frame of the macro base station device is often set in a position for protecting a control signal of a small-size public base station device or the like, it is possible to protect a control signal of a small-size public base station device or the like by setting the blank section of the base station device in the frame position corresponding to the blank section in the transmission frame of the macro base station device.

[14.4] The base station device according to any one of [14.1] to [14.3], wherein when the determination unit has determined that no small-size public base station device is present in the neighborhood of the base station device, the setting unit sets the blank section in a frame position corresponding to a transmission section for transmitting a control signal contained in a transmission frame of a macro base station device that forms a macro cell.

When no small-size public base station device is present in the neighborhood of the base station device, it is possible to protect the control signal contained in the transmission frame of the macro base station device.

[14.5] The base station device according to any one of [14.1] to [14.4], wherein the determination unit performs the determination as to whether a small-size public base station device is present in the neighborhood of the base station device, based on information wirelessly transmitted from a neighboring base station device that is present in the neighborhood of the base station device.

[14.6] The base station device according to any one of [14.1] to [14.5], wherein the determination unit performs the determination as to whether a small-size public base station device is present in the neighborhood of the base station device, based on transmission power information transmitted by a neighboring base station device that is present in the neighborhood of the base station device.

[14.7] The base station device according to any one of [14.1] to [14.5], wherein the determination unit performs the determination as to whether a small-size public base station device is present in the neighborhood of the base station device, based on ID information of the base station device, which is transmitted by a neighboring base station device that is present in the neighborhood of the base station device.

[14.8] The base station device according to any one of [14.1] to [14.5], wherein the determination unit performs the determination as to whether a small-size public base station device is present in the neighborhood of the base station device, by determining whether a transmission frame transmitted by a neighboring base station device in the neighborhood of the base station device contains information indicating that the neighboring base station device is a small-size public base station device.

[14.9] The base station device according to any one of [14.1] to [14.5], wherein the determination unit performs the determination as to whether a small-size public base station device is present in the neighborhood of the base station device, by determining whether a transmission frame transmitted by a neighboring base station device in the neighborhood of the base station device contains information indicating that another base station device that is present in the neighborhood of the neighboring base station device is a small-size public base station device.

[14.10] The base station device according to [14.9], wherein the determination unit performs the determination as to whether a small-size public base station device is present in the neighborhood of the base station device, taking into consideration a result of measurement of a signal from the another base station device.

[14.11] The base station device according to any one of [14.1] to [14.10], wherein the determination unit performs the determination as to whether a small-size public base station device is present in the neighborhood of the base station device, based on a monitoring result as to whether a neighboring base station device that is present in the neighborhood of the base station device performs cell range expansion.

[14.12] The base station device according to any one of [14.1] to [14.11], wherein the determination unit performs the determination as to whether a small-size public base station device is present in the neighborhood of the base station device, based on information acquired via an inter-base-station network.

[14.13] The base station device according to [14.12], wherein the determination unit performs the determination as to whether a small-size public base station device is present in the neighborhood of the base station device, based on information indicating whether a small-size public base station device is present in the neighborhood of the base station device, the information being acquired via the inter-base-station network.

[14.14] A base station device which is a small-size public base station device that forms a cell smaller than a macro cell, and is configured to be able to transmit a transmission frame including information indicating that the base station device is a small-size public base station device.

[14.15] A base station device which is configured to be able to transmit a transmission frame including information indicating another base station device that is present in the neighborhood of the base station device, and information indicating whether the another base station device is a small-size public base station device that forms a cell smaller than a macro cell.

[14.16] A communication system including a first base station device that forms a macro cell, a second base station device which is a small-size public base station device that forms a cell smaller than the macro cell, and a third base station device which can be privately used by customers of a telecommunications carrier, such as individuals or companies, wherein the first base station device is configured to set a blank section during which no data signal is transmitted, in a frame position corresponding to a transmission section for transmitting a control signal contained in a transmission frame of the second base station device, and the third base station device includes: a setting unit that sets, in a transmission frame, a blank section during which no data signal is transmitted; and a determination unit that determines whether the second base station device is present in the neighborhood of the third base station device, wherein the setting unit adjusts the position where the blank section is set, in accordance with a result of the determination as to whether the second base station device is present in the neighborhood of the third base station device.

[14.17] A management device for managing information of a plurality of base station devices, comprising: a storage unit having stored therein information indicating the type of each of the plurality of base station devices; and an information transmission unit for transmitting, when a second base station device which is a small-size public base station device that forms a cell smaller than a macro cell is present in the neighborhood of a first base station device that can be privately used by customers of a telecommunications carrier, such as individuals or companies, information indicating that the small-size public base station device is present in the neighborhood of the first base station device, to the first base station device.

[14.18] A management device for managing information of a plurality of base station devices, comprising: a storage unit having stored therein information indicating the type of each of the plurality of base station devices; and an information transmission unit for transmitting, to a base station device, information indicating the type of another base station device.

[14.19] A method for setting a blank section during which no data signal is transmitted, in a frame transmitted by a base station device, the method comprising the steps of: determining whether a small-size public base station device that forms a cell smaller than a macro cell is present in the neighborhood of the base station device that can be privately used by customers of a telecommunications carrier, such as individuals or companies; and adjusting the position of the blank section in a frame transmitted by the base station device that can be privately used by customers of a telecommunications carrier, such as individuals or companies, in accordance with a result of the determination as to whether a small-size public base station device is present in the neighborhood of the base station device.

[14.20] A method for performing determination regarding a neighboring base station device, the method comprising the steps of: transmitting, from a device provided in an inter-base-station network or a device provided in a network connected to an inter-base-station network, information to be used for determining whether a small-size public base station device that forms a cell smaller than a macro cell is present in the neighborhood of the base station device; receiving, by the base station device, the information transmitted via the inter-base-station network; and performing, based on the information, the determination as to whether a small-size public base station device is present in the neighborhood of the base station device.

[14.21] A method for transmitting, by a small-size public base station device that forms a cell smaller than a macro cell, information regarding itself, wherein the small-size base station device transmits, as the information regarding itself, information indicating that the base station device is a small-size public base station device.

[14.22] A method for transmitting, by a base station device, information indicating another base station device that is present in the neighborhood of the base station device, wherein the base station device transmits, in addition to the information indicating the another base station device that is present in the neighborhood of the base station device, information indicating whether the another base station device is a small-size public base station device that forms a cell smaller than a macro cell.

### 15. Appended Note 2

Note that the embodiment disclosed herein is merely illustrative in all aspects and should not be recognized as being restrictive. The scope of the present invention is defined by the scope of the claims rather than by the meaning described above, and is intended to include meaning equivalent to the scope of the claims and all modifications within the scope.

For example, the position in a frame, where a blank subframe (blank section) is set, is not limited to the position of a control signal in a macro BS or a pico BS, but may be any position where a radio wave radiated from a femto BS is likely to cause a problem.

### DESCRIPTION OF REFERENCE CHARACTERS

1 base station device (1a: macro base station device, 1b: pico base station device, 1c: femto base station device)
2 terminal device
3 MME
5 gateway
6 S1 interface
7 X2 interface
9 server (management device)
9a storage unit
9b determination unit
9c information transmission unit
24 blank radio resource (blank section) setting unit
25 determination unit
26 information acquisition unit

1. A base station device comprising:
a setting unit that sets a blank radio resource in a usable radio resource; and
an acquisition unit that acquires information indicating the position of a blank radio resource in another base station device, wherein
the setting unit adjusts the position of the blank radio resource, based on the information indicating the position of the blank radio resource in the another base station device.

2. The base station device according to claim 1, wherein
the another base station device is a target base station device to be referred to for the position of a blank radio resource among a plurality of other base station devices, and
the setting unit adjusts the position of the blank radio resource, based on the information indicating the position of the blank radio resource in the target base station device.

3. The base station device according to claim 1, wherein the blank radio resource in the another base station device is a blank radio resource that is set for preventing interference to a cell of still another base station device different from the another base station device.

4. The base station device according to claim 1, wherein the another base station device is higher in priority of access by a terminal device than the base station device.

5. The base station device according to claim 4, wherein
the blank radio resource in the another base station device is a blank radio resource which is set for preventing interference to a cell of a preferential base station device, and
the preferential base station device is still another base station device different from the another base station device, and is higher in priority of access by a terminal device than the another base station device.

6. The base station device according to claim 1, wherein the another base station device is lower in priority of access by a terminal device than the base station device.

7. The base station device according to claim 6, wherein
the blank radio resource in the another base station device is a blank radio resource which is set for preventing interference to a cell of a preferential base station device, and
the preferential base station device is still another base station device different from the another base station device, and is higher in priority of access by a terminal device than the base station device.

8. The base station device according to claim 5, wherein the preferential base station device is a neighboring base station device that is present in the neighborhood of the base station device.

9. The base station device according to claim 1, wherein the another base station device is a macro base station device that forms a macro cell.

10. The base station device according to claim 3, wherein the still another base station device different from the another base station device is a small-size public base station device that forms a cell smaller than a macro cell.

11. The base station device according to claim 1, which is a base station device that can be privately used by customers of a telecommunications carrier, such as individuals or companies.

12. The base station device according to claim 1, which is a small-size public base station device that forms a cell smaller than a macro cell.

13. The base station device according to claim 3, wherein the still another base station device different from the another base station device is a second public base station device that forms a cell smaller than a cell of a first small-size public base station device that forms a cell smaller than a macro cell.

14. The base station device according to claim 1, wherein the setting unit sets the blank radio resource in a position corresponding to the position of the blank radio resource in the another base station device.

15. The base station device according to claim 1, wherein the setting unit sets the blank radio resource in a position different from the position of the blank radio resource in the another base station device.

16. The base station device according to claim 1, wherein the radio resource is a time resource or a frequency resource.

17. The base station device according to claim 1, comprising a determination unit that determines whether still another base station device different from the another base station device is present in the neighborhood of the base station device, wherein
the setting unit adjusts the position of the blank radio resource, based on a result of the determination as to whether still another base station device different from the another base station device is present in the neighborhood of the base station device.

18. The base station device according to claim 17, wherein
when the determination unit has determined that still another base station device different from the another base station device is present in the neighborhood of the base station device,
the setting unit adjusts the position of the blank radio resource, based on the information indicating the position of the blank radio resource in the another base station device.

19. The base station device according to claim 17, wherein
when the determination unit has determined that still another base station device different from the another base station device is not present in the neighborhood of the base station device,
the setting unit adjusts the position of the blank radio resource in order to prevent interference to a cell of the another base station device.

20. The base station device according to claim 17, wherein the determination unit performs the determination as to whether still another base station device different from the another base station device is present in the neighborhood of the base station device, based on information wirelessly transmitted by a neighboring base station device that is present in the neighborhood of the base station device.

21. The base station device according to claim 17, wherein the determination unit performs the determination as to whether still another base station device different from the another base station device is present in the neighborhood of the base station device, based on transmission power information transmitted by a neighboring base station device that is present in the neighborhood of the base station device.

22. The base station device according to claim 5, comprising a determination unit that determines whether the preferential base station device is present in the neighborhood of the base station device, wherein
the setting unit adjusts the position of the blank radio resource, based on a result of the determination as to whether the preferential base station device is present in the neighborhood of the base station device.

23. The base station device according to claim 22, wherein the determination unit performs the determination as to whether the preferential base station device is present in the neighborhood of the base station device, based on ID information of the base station device, which is transmitted by a neighboring base station device that is present in the neighborhood of the base station device.

24. The base station device according to claim 22, wherein the determination unit performs the determination as to whether the preferential base station device is present in the neighborhood of the base station device, by determining whether a transmission frame transmitted by a neighboring base station device in the neighborhood of the base station device contains information which allows recognition that the neighboring base station device is the preferential base station device.

25. The base station device according to claim 22, wherein the determination unit performs the determination as to whether the preferential base station device is present in the neighborhood of the base station device, by determining whether a transmission frame transmitted by a neighboring base station device in the neighborhood of the base station device contains information which allows recognition that still another base station device that is present in the neighborhood of the neighboring base station device is the preferential base station device.

26. The base station device according to claim 25, wherein the determination unit performs the determination as to whether the preferential base station device is present in the neighborhood of the base station device, taking into consideration a result of measurement of a signal transmitted from the still another base station device.

27. The base station device according to claim 22, wherein the determination unit performs the determination as to whether the preferential base station device is present in the neighborhood of the base station device, based on a monitoring result as to whether a neighboring base station device that is present in the neighborhood of the base station device performs cell range expansion.

28. The base station device according to claim 17, wherein the determination unit performs the determination as to whether still another base station device different from the another base station device is present in the neighborhood of the base station device, based on information acquired via an inter-base-station network.

29. The base station device according to claim 28, wherein the determination unit performs the determination as to whether still another base station device different from the another base station device is present in the neighborhood of the base station device, based on information indicating whether still another base station device different from the another base station device is present in the neighborhood of the base station device, the information being acquired via the inter-base-station network.

30-31. (canceled)

32. A communication system including:
a first base station device;
a second base station device; and
a third base station device, wherein
the first base station device is configured to set, in a usable radio resource, a blank radio resource for preventing interference to a cell of the second base station device, and
the third base station device acquires information indicating the position of the blank radio resource in the first base station device, and adjusts the position of the blank radio resource, based on the information indicating the position of the blank radio resource in the first base station device.

33-34. (canceled)

35. A method of setting a blank radio resource in a radio resource that a base station device can use, the method comprising the steps of:
acquiring information indicating the position of a blank radio resource in another base station device; and
adjusting the position of the blank radio resource in the base station device, based on the information indicating the position of the blank radio resource in the another base station device.

36. A method of performing determination regarding a neighboring base station device, the method comprising the steps of:
transmitting, from a device provided in an inter-base-station network or a device provided in a network connected to an inter-base-station network, information to be used for determining whether, in the neighborhood of one base station device, another base station device of a type different from the type of the one base station device is present;
receiving, by the one base station device, the information transmitted via the inter-base-station network; and
performing, based on the information, the determination as to whether, in the neighborhood of the one base station device, another base station device of a type different from the type of the one base station device is present.

37-38. (canceled)
